(19) United States
(12) Patent Application Publication
(10) Pub. No.: US 2025/0355921 A1
(43) Pub. Date: Nov. 20, 2025

(54) Systems and Methods for Improving Accuracy of Large Language Models

(71) Applicant: System Inc., New York, NY (US)

(72) Inventors: Mehdi Jamei, Chappaqua, NY (US); David Kang, New York City, NY (US); Frank Fu, New York City, NY (US); Sol Vitkin, New York City, NY (US); Victor Shih, New York City, NY (US); Adam Bly, New York City, NY (US)

(21) Appl. No.: 19/206,932

(22) Filed: May 13, 2025

Related U.S. Application Data
(60) Provisional application No. 63/649,661, filed on May 20, 2024.

(51) Int. Cl. G06F 16/35; G06F 16/334; G06F 16/34; G06F 40/30

(52) U.S. Cl. CPC G06F 16/35; G06F 16/334; G06F 16/345; G06F 40/30

(57) ABSTRACT

Systems and methods for improving the accuracy of information obtained using a large language model. In one embodiment, this involves augmenting the capabilities of a graph generated from unstructured data with information from an external source using Retrieval Augmented Generation (RAG). In one embodiment, expert knowledge is used to review clustering and cluster summarizations derived from the results of a search over the graph data and information prior to application of RAG to generate additional information to augment the search results.

### CROSS REFERENCE TO RELATED APPLICATION

This application claims the benefit of U.S. Provisional Application No. 63/649,661, filed May 20, 2024, entitled “Systems and Methods for Improving Accuracy of Large Language Models”, the disclosure of which is incorporated, in its entirety (including the Appendix) by this reference.

References herein to “System” in the context of an architecture or to the System Graph, architecture, or platform refer to the architecture, platform, and processes for enabling and performing a statistical search and other forms of data organization described in U.S. Pat. No. 11,354,587 issued Jun. 7, 2022, which claims priority from U.S. patent application Ser. No. 16/421,249, entitled “Systems and Methods for Organizing and Finding Data”, filed May 23, 2019, which claims priority from U.S. Provisional Patent Application Ser. No. 62/799,981, entitled “Systems and Methods for Organizing and Finding Data”, filed Feb. 1, 2019, the entire contents of all of which (and of any application claiming priority directly or indirectly to one or more of the mentioned applications) are incorporated by reference in their entirety into this application.

### BACKGROUND

Large Language Models (LLMs) have become important tools in a variety of fields, including healthcare and biomedical research. These models, as vast repositories of knowledge, assist in numerous tasks due to their extensive pre-training. Despite their advantages, LLMs encounter specific challenges in the field of biomedical research, which is characterized by rapid advancements and the continual emergence of new data and results.

One limitation of LLMs is their reliance on pre-existing datasets for training, as this can result in the use of information that has become outdated in a faster-evolving area such as biomedicine. This presents a significant hurdle in maintaining the relevance and accuracy of the outputs, as new(er) data may result in differences in the trained response(s) of an LLM. Additionally, the difficulty in verifying the reliability of information produced by LLMs poses a critical challenge, especially in healthcare where precision and accuracy are of utmost importance. Compounding these issues is the propensity of LLMs to generate responses that appear credible but may lack factual basis, and which are often provided without direct citations, thus further complicating the verification process for the information they provide.

Embodiments of the systems and methods disclosed and/or described herein are directed to solving these and related problems individually and collectively.

### SUMMARY

The terms “invention,” “the invention,” “this invention,” “the present invention,” “the present disclosure,” or “the disclosure” as used herein refer broadly to all subject matter disclosed and/or described in this document, the drawings or figures, and to the claims. Statements containing these terms do not limit the subject matter described or the meaning or scope of the claims. Embodiments of this disclosure are defined by the claims and not by this summary. This summary is a high-level overview of various aspects of the disclosure and introduces some of the concepts that are further described in the Detailed Description section. This summary is not intended to identify key, essential, or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments of the disclosure are directed to a system and methods for improving the accuracy of information obtained from using a large language model (LLM). In one embodiment, this involves augmenting the capabilities of a graph generated from unstructured data with information from an external source using Retrieval Augmented Generation (referred to as RAG, a description of which may be found at https://research.ibm.com/blog/retrieval-augmented-generation-RAG).

In one embodiment, a subject matter expert reviews the clustering and cluster summarizations derived from the results of a search over the graph data and information. This is performed prior to the application of RAG, which then generates additional information to augment the search results.

Embodiments address the challenges of using large language models by leveraging the ability of such models to build structured data (in the form of a graph) from unstructured knowledge bases and to synthesize relevant parts of the graph based on a user's query. A novel approach is introduced that employs the System Graph (as described in the aforementioned U.S. Pat. No. 11,354,587) in combination with Retrieval Augmented Generation (RAG).

Embodiments provide a mechanism that operates to continuously grow a graph of structured data, retrieve and cluster relevant findings based upon a query, and accurately synthesize and reference those findings. This combination of functions or operations is specifically tailored to improve the accuracy and timeliness of information processing in biomedical research (or other domain) and addresses the core issues of concern when using an LLM, that is outdated content, reliability, and factual verification of LLM generated outputs.

In some embodiments, the disclosed system and methods may comprise elements, components, functions, operations, or processes that are configured and operate to provide one or more of:
Ingestion of source materials;
   Peer-reviewed studies and curated databases are identified, discovered, and collected;
      The ingestion process may be performed daily or on an otherwise regular basis;
Extraction of relevant data or information from the ingested source materials;
   This step or stage is focused on identifying statistical (e.g., statistically relevant) and/or causal relationships in the source materials;
      As a non-limiting example, one methodology for identifying and extracting statistical relationships from source materials is disclosed in U.S. patent application Ser. No. 18/643,248, entitled “System and Methods for Extracting Statistical Information from Documents,” filed Apr. 23, 2024, the disclosure of which is incorporated in its entirety by this reference;
      Causal or other forms of relationships may be identified and/or extracted using an LLM trained on specific data. As an example, see https://academic.oup.com/database/article/doi/10.1093/database/bay098/5107029 for one approach to identifying or determining the presence of a causal relationship;
Postprocessing of the extracted data (which may include metadata) and information;
   In some embodiments, this may include a process to perform one or more of quality assurance, deduplication of variables, or ontology grounding of terms, variables, or concepts;
      This may include concept “tagging”, labeling, or other similar function to identify characteristics or features of importance for use in other stages of the data or metadata processing;
      The use of an ontology or ontologies may assist in identifying “similar” or related terms, variables, or concepts—this can be used to expand the set of relationships that are identified;
Storage of the post-processed data and information (which may include metadata);
   This may include organizing the data and information into one or more of a “System” knowledge or feature graph, SQL, or vector database for retrieval and analysis;
Execute a search over the stored data and information in response to a query;
   In one embodiment, this is a search executed in (or over) both the ingested sources and the extracted data or information;
   In one embodiment, the search process may include use of one or more of synonym expansion (based on an ontology), PubMed's Best Match algorithm (or other algorithm specific to a domain), and a semantic similarity ranking;
   In one embodiment, the search results may be presented to a user in the form of a System Graph, knowledge graph, or feature graph (as disclosed in the aforementioned U.S. Pat. No. 11,354,587), examples of which are illustrated in FIGS. 1(s) and 1(t);
Clustering or otherwise grouping of “similar” findings (i.e., the extracted data or information) from the ingested sources in response to the search query and summarizing them;
   This step or stage assists in providing a more accurate synthesis of the search results;
   Summarizing the content of each cluster;
      In one embodiment, this may include consideration of rules or guidelines prepared by a subject matter expert and/or review and confirmation by the expert of a summary generated by an LLM;
         The rules and/or guidelines may be implemented by the software used to execute the disclosed and/or described processes;
Synthesis and/or enhancement of the clustered or grouped results;
   In one embodiment, a comprehensive synthesis of the search results is generated by leveraging one or more trained LLMs to create/identify headings, assign (or reassign) clusters, and/or expand content based on user queries and/or clustered findings;
      In one embodiment, this may include use of techniques (such as RAG) to assist in creating and/or elaborating upon headings or research questions to produce a more comprehensive synthesis of the research;
   One use case for this approach is to construct a meta-analysis of the search results in a more efficient manner; and
Validation of the synthesized results using a systematic validation protocol;
   This provides additional confirmation of the relevance and accuracy of the summarized results of the search.

In one embodiment, the disclosure is directed to a system for improving the accuracy of information obtained from using a large language model. The system may include a set of computer-executable instructions and an electronic processor or co-processors. When executed by the processor or co-processors, the instructions cause the processor or co-processors (or a device of which they are part) to perform a set of operations that implement an embodiment of the disclosed method or methods.

In one embodiment, the disclosure is directed to a set of computer-executable instructions, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed and/or described herein may provide services through a SaaS or multi-tenant platform. The platform provides access to multiple entities, each with a separate account and associated data storage. Each account may correspond to a user, set of users, an entity, a set of entities, a set of source materials, a domain, a sub-domain, a specific task, or an organization (such as an educational, research, or governmental institution), for example. Each account may access one or more services, a set of which are instantiated in their account, and which implement one or more of the methods or functions disclosed and/or described herein.

In some embodiments, a “private” form of the disclosed and/or described system and associated methods may be made available to an organization (such as a commercial provider of products or services) and may include access to proprietary data and information which is used to generate a System Graph.

Other objects and advantages of the systems, apparatuses, and methods disclosed and/or described herein may be apparent to one of ordinary skill in the art upon review of the detailed description and the included figures. Throughout the drawings, identical reference characters and descriptions indicate similar, but not necessarily identical, elements. While the embodiments disclosed and/or described herein are susceptible to various modifications and alternative forms, specific embodiments are shown by way of example in the drawings and are described in detail herein. However, embodiments of the disclosure are not limited to the exemplary or specific forms described. Rather, the present disclosure covers all modifications, equivalents, and alternatives falling within the scope of the appended claims.

### BRIEF DESCRIPTION OF THE DRAWINGS

Embodiments of the invention in accordance with the present disclosure will be described with reference to the drawings, in which:

FIG. 1(a)-1 is a flowchart or flow diagram illustrating a method, process, set of operations, or set of functions for improving the accuracy of information obtained from using a large language model, in accordance with some embodiments;

FIG. 1(a)-2 is a diagram illustrating the processing flow described with reference to FIG. 1(a)-1;

FIG. 1(b) is a diagram illustrating a set of elements or components and associated processes, functions, or operations that may be used to implement an embodiment of the disclosure;

FIG. 1(c) is a table of curated databases that have been integrated with one embodiment of the disclosure;

FIG. 1(d) is a table that provides an overview of the relationship components;

FIG. 1(e) is a diagram illustrating two examples of the extractions;

FIG. 1(f) is a graph illustrating the performance of the tagging model across several threshold settings;

FIG. 1(g) is a Table containing examples of tagged variables and their corresponding topics;

FIG. 1(h) is a Table of showing validation of the model results using the Surge platform for an unbiased third-party assessment;

FIG. 1(i) is a diagram illustrating elements, components, and processes that may be implemented in an embodiment of extraction and processing operations or functions applied to a corpus of sources;

FIG. 1(j) is a Table showing the current state of the overall System Graph and lists the counts of variables, topics, and their interconnections;

FIG. 1(k) is a Table showing examples of the objects and their associated embedding models;

FIG. 1(l) is an illustration of an example of a Search algorithm that may be implemented by an embodiment;

FIG. 1(m) is a Table showing examples of user queries and their corresponding expanded counterparts that may be used in an embodiment;

FIG. 1(n) are diagram(s) demonstrating the dispersal of System variables in a 2D projection utilizing menadsa/S-PubMedBERT alongside another model;

FIG. 1(o) is a diagram illustrating the components of a synthesis generation process in accordance with an embodiment of the disclosure;

FIG. 1(p) is a Table showing an example list of validations for each synthesis section;

FIGS. 1(q) and 1(r) are Tables showing metrics for each pipeline stage and provide a holistic view of the overall pipeline's efficacy;

FIG. 1(s) is an example of a Topic graph that may be generated using the System platform and processes disclosed and/or described herein;

FIG. 1(t) is an example of a Variable graph that may be generated using the System platform and processes disclosed and/or described herein;

FIG. 1(u) is an example output of the processes and operations disclosed and/or described herein;

FIG. 1(v) is a second example output of the processes and operations disclosed and/or described herein;

FIG. 2 is a diagram illustrating elements or components that may be present in a computer device, server, or system configured to implement a method, process, function, or operation in accordance with some embodiments; and

FIGS. 3-5 are diagrams illustrating an architecture for a multi-tenant or SaaS platform that may be used in implementing an embodiment of the systems and methods described herein.

Note that the same numbers are used throughout the disclosure and figures to reference like components and features.

### DETAILED DESCRIPTION

The subject matter of embodiments of the present disclosure is described herein with specificity to meet statutory requirements, but this description does not limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure are described more fully herein with reference to the accompanying drawings, which form a part hereof, and which show, by way of illustration, exemplary embodiments by which the disclosure may be practiced. The disclosure may be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods disclosed and/or described herein may be implemented by one or more processing elements (such as a processor, microprocessor, CPU, GPU, TPU, QPU, or controller) that are part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods may be implemented by a specialized form of hardware, such as a programmable gate array, application specific integrated circuit (ASIC), or the like. Note that an embodiment of the disclosure may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, in some embodiments, the systems, apparatuses, and methods disclosed and/or described herein may provide services through a SaaS or multi-tenant platform. The platform provides access to multiple entities, each with a separate account and associated data storage. Each account may correspond to a user, set of users, an entity, a set of entities, a set of source materials, a domain, a sub-domain, a specific task, or an organization, for example. Each account may access one or more services, a set of which are instantiated in their account, and which implement one or more of the methods or functions described herein.

As used herein, the following terms have at least the indicated meaning:
A “System Graph” refers to a set of nodes and edges connecting one node to another or to multiple nodes. Each node represents an entity, in some cases a topic of study or a variable or factor considered in a study. Edges may represent statistical or mechanistic connections found in one or more individual studies as a result of extracting data and information from the studies. A System Graph may also be referred to as a Topic graph, a Variable graph, a feature graph, or a knowledge graph;
“Synthesis” or “System Synthesis” of a relationship or topic refers to a process of analyzing and/or evaluating the contents of one or more sources of data and/or information (such as a report, investigation, or article, along with accompanying metadata) found by traversing a System Graph to generate a comprehensive and accurate summary or other form of that data and information;
Meta-analysis—this refers to a tool or approach used to accumulate and summarize the knowledge in a research field;
Statistical correlations—a statistical relationship or correlation describes a connection between an independent and a dependent variable, its strength and a measure of the statistical confidence in that connection;
Mechanistic linkages—a mechanistic linkage describes a causal connection (usually at the molecular level for biomedical investigations) that is manifested in a chemical or physical process.

Embodiments address the challenges of using large language models by leveraging the ability of such models combined with the approach disclosed herein to build structured data (in the form of a knowledge or feature graph) from unstructured knowledge bases and to synthesize relevant parts of the graph based on a user's query. A novel approach is introduced that employs the System Graph (as described in the aforementioned U.S. Pat. No. 11,354,587) in combination with Retrieval Augmented Generation (RAG) to perform these functions.

Embodiments provide a set of processes that operate to continuously develop and maintain a graph of structured data, retrieve and cluster relevant findings based upon a query, and accurately synthesize and validate those findings. This combination of functions or operations is specifically tailored to improve the accuracy and timeliness of information processing in biomedical research or other domain, and addresses issues of concern when using an LLM, including those of outdated content, reliability, and factual verification of LLM generated outputs.

A potential benefit of the disclosed and/or described approach is to assist in creating an accurate, comprehensive, and up-to-date tool for researchers in the biomedical and healthcare sectors (or other domain), where frequent literature review is a common task. The approach represents an integration of LLMs within a Retrieval Augmented Generation (RAG) and Graph-based knowledge system, and at a larger scale than attempted with conventional approaches. One objective is to augment the capabilities of LLMs in synthesizing current and accurate biomedical research data (or other domain), thereby contributing to the research tools available in the field.

This disclosure includes a description of the components of an embodiment of the disclosed system and includes information regarding the performance and implementation of each component and the associated processes. Also included is a discussion of experiments and surveys conducted to assess the accuracy, comprehensiveness, and other facets of the disclosed solution.

The following describes a set of components, elements, functions, and processes for implementing an embodiment of the proposed framework and how they interact to generate a synthesis of research in response to a given search query.

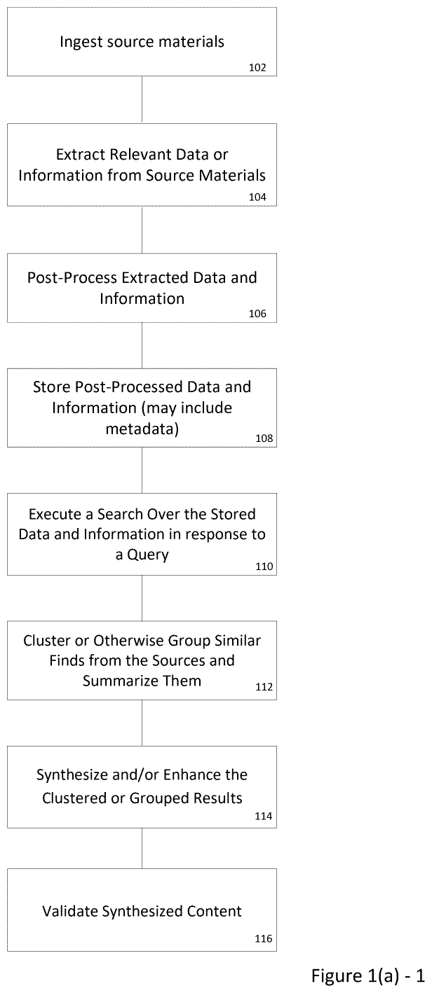

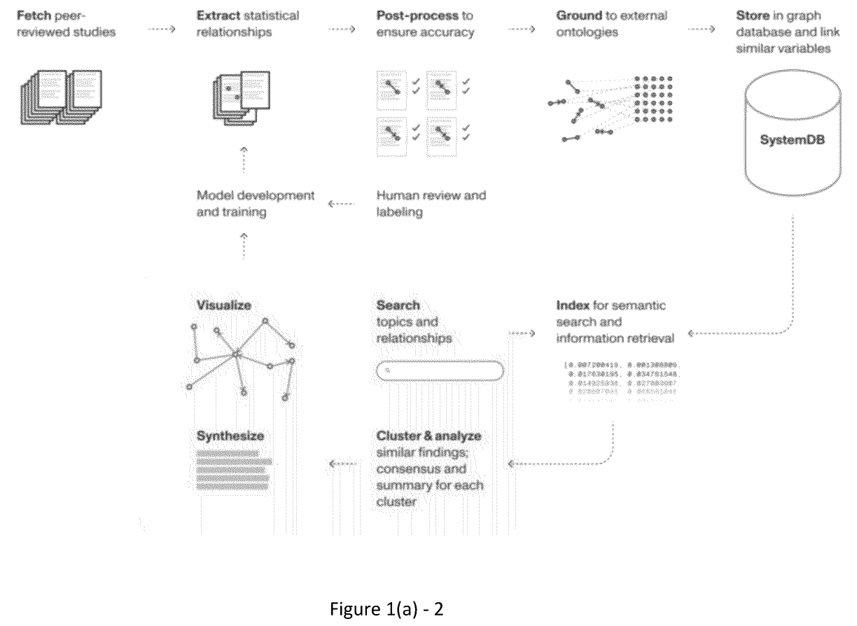

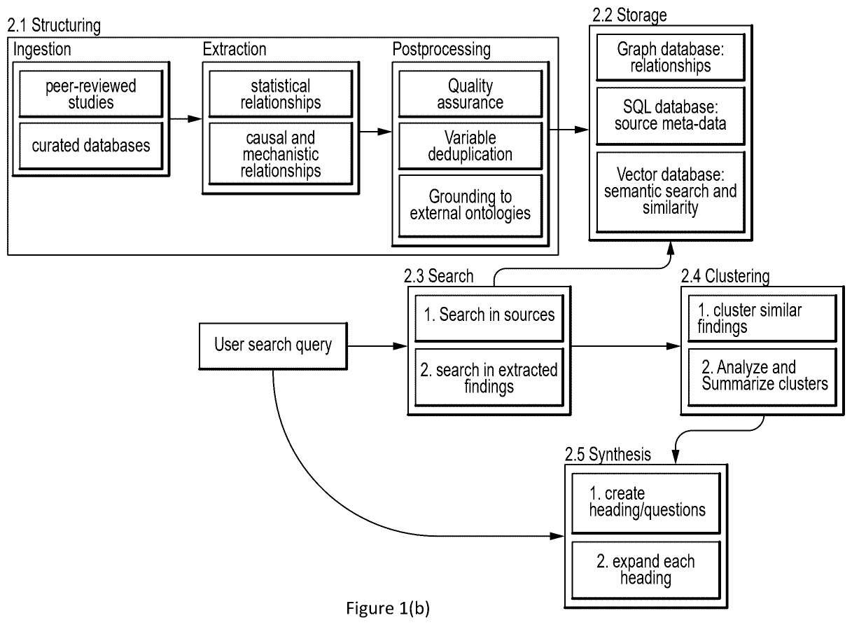

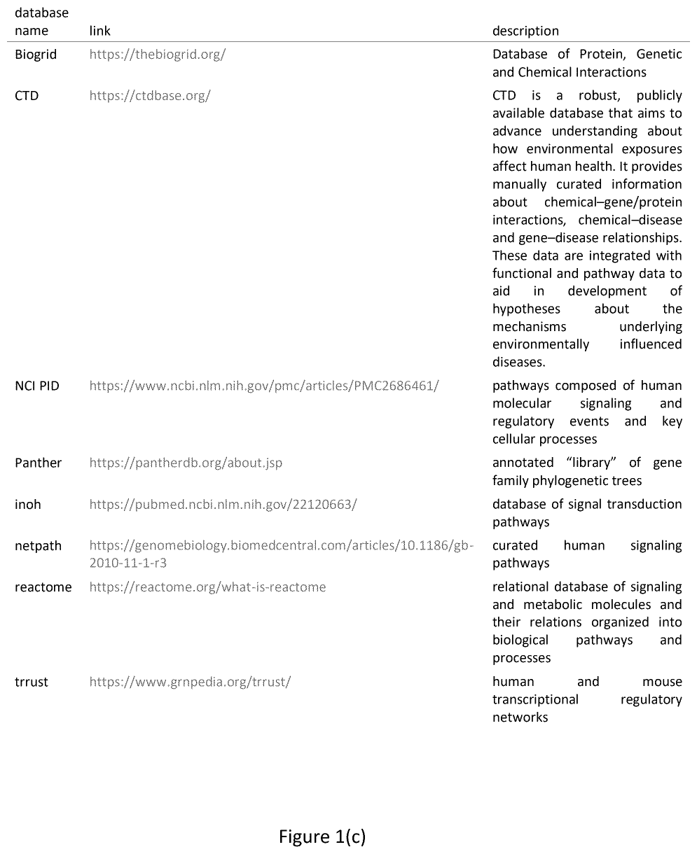

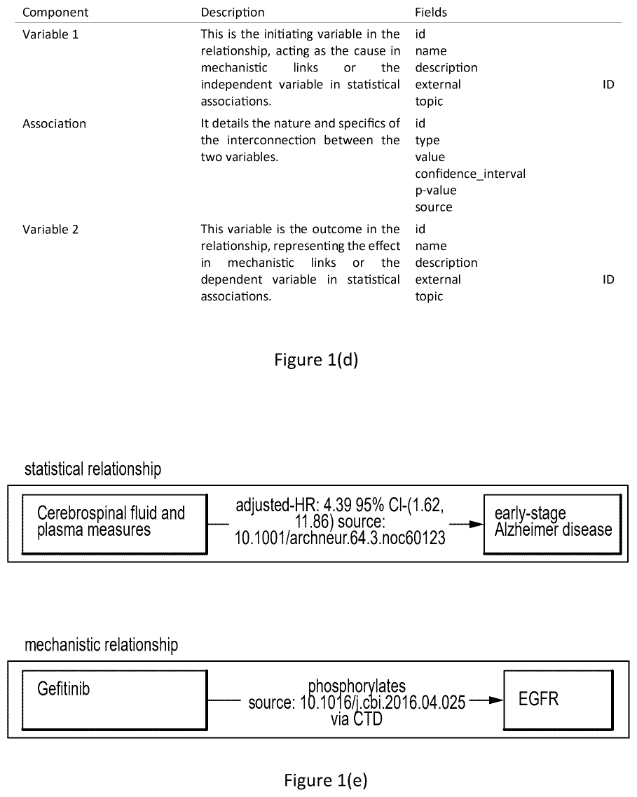

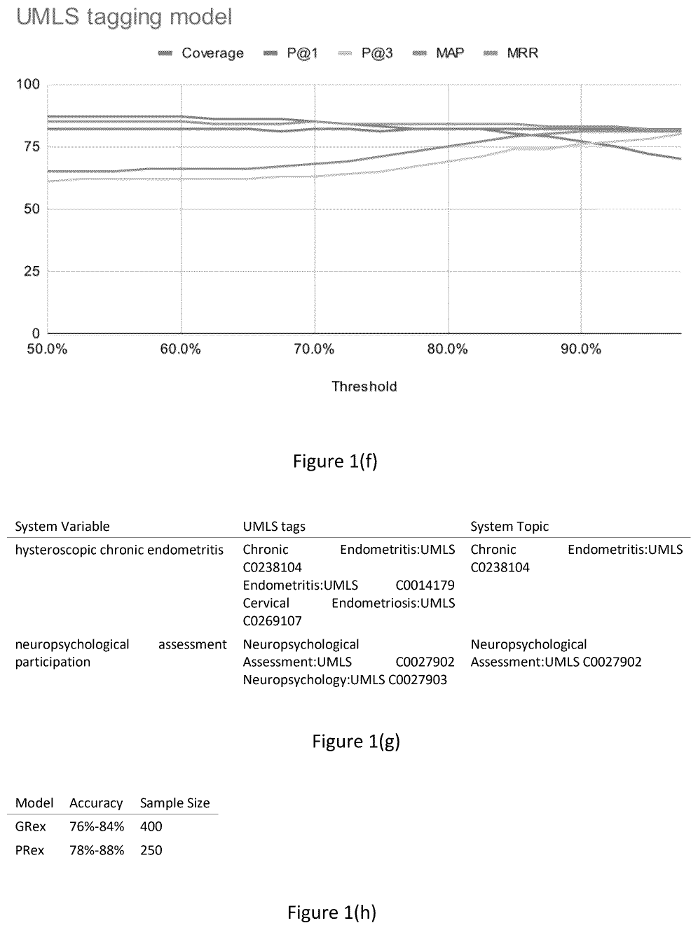

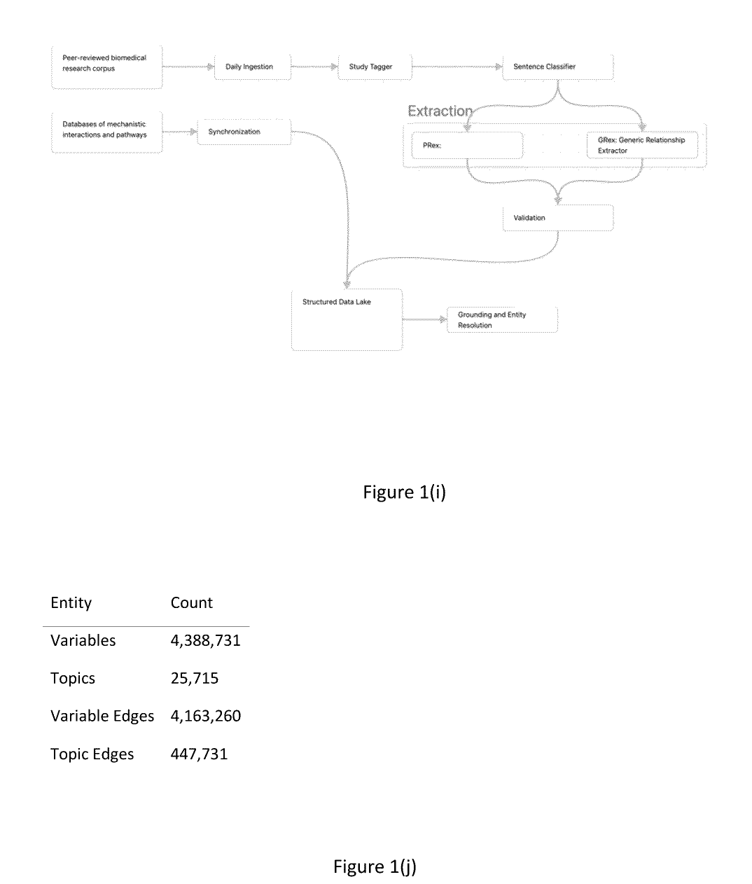

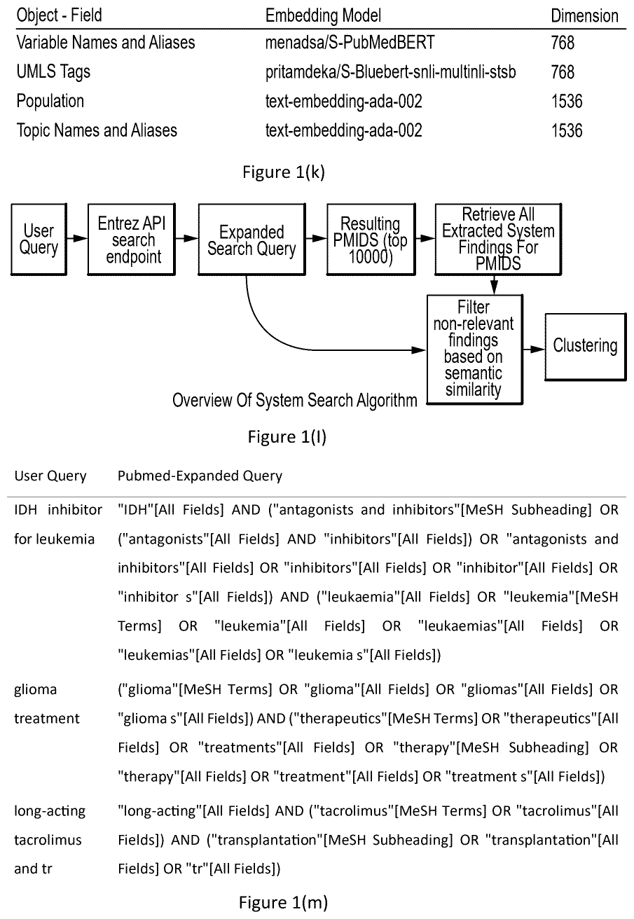

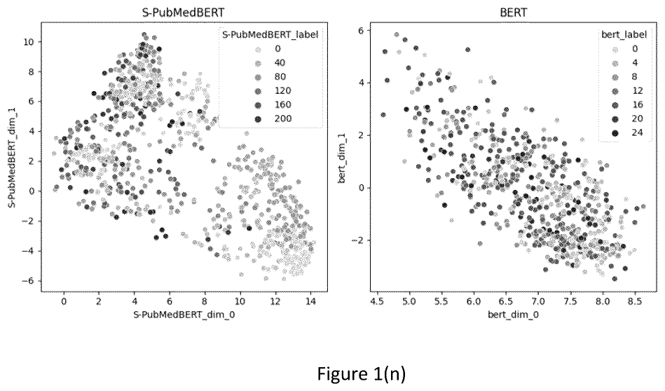

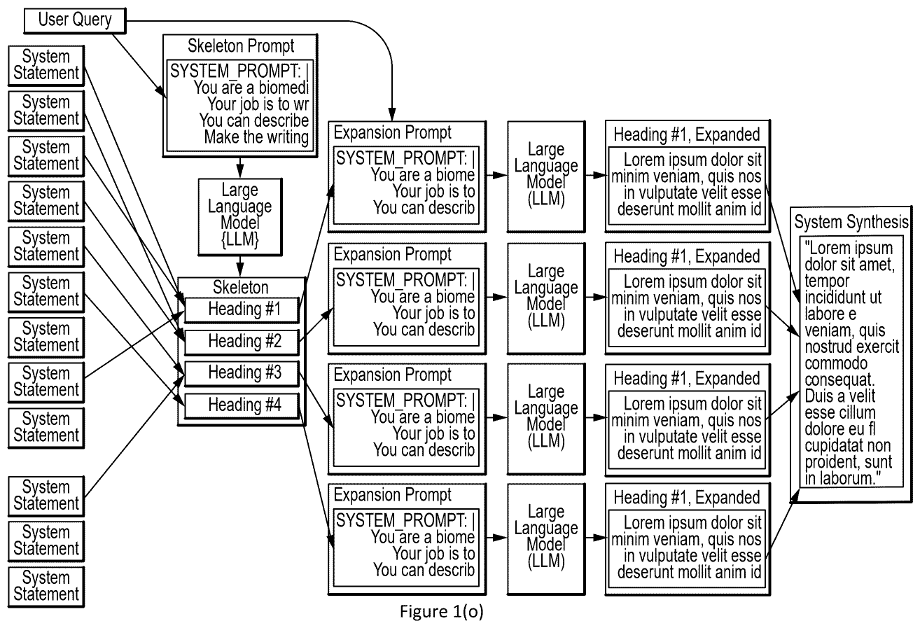

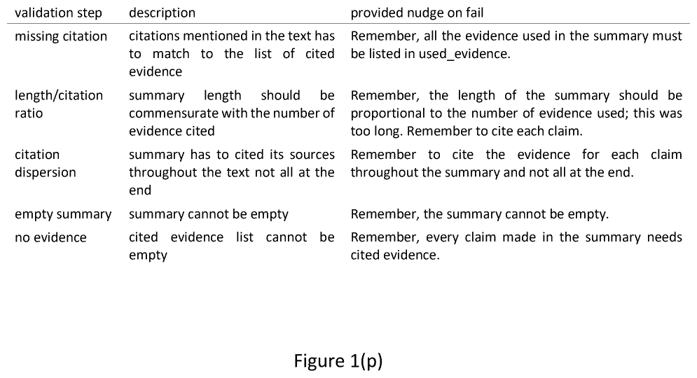

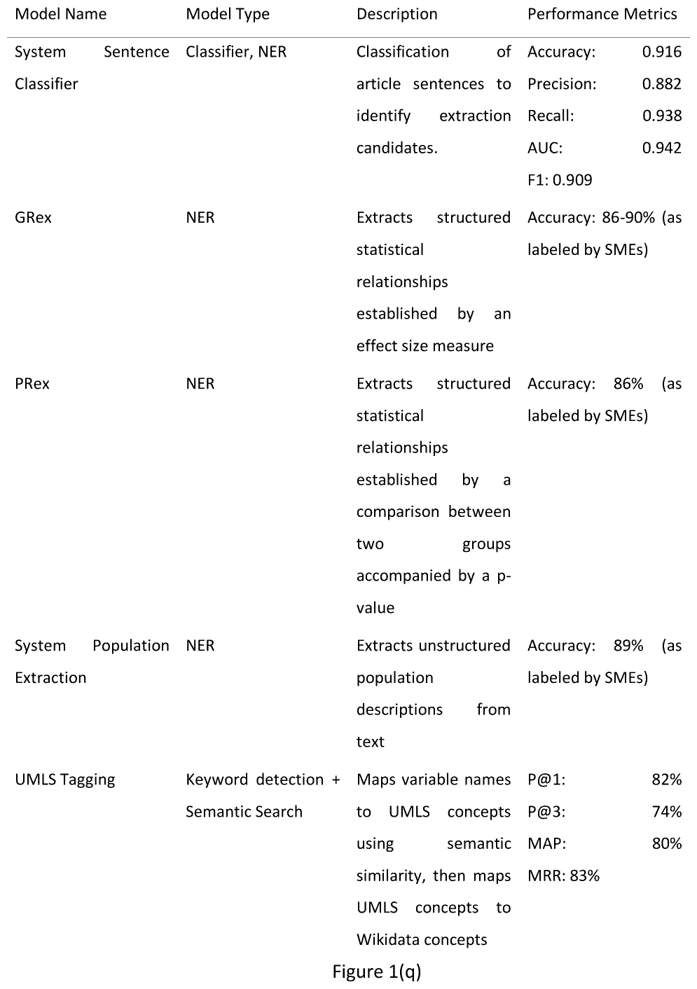

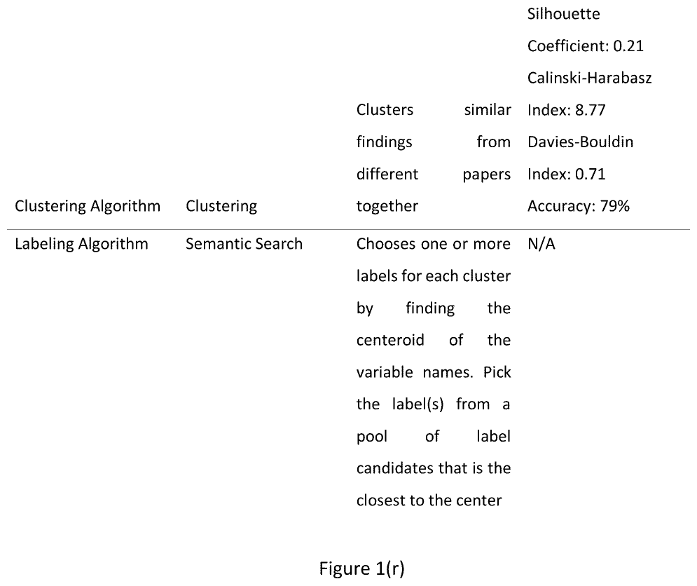

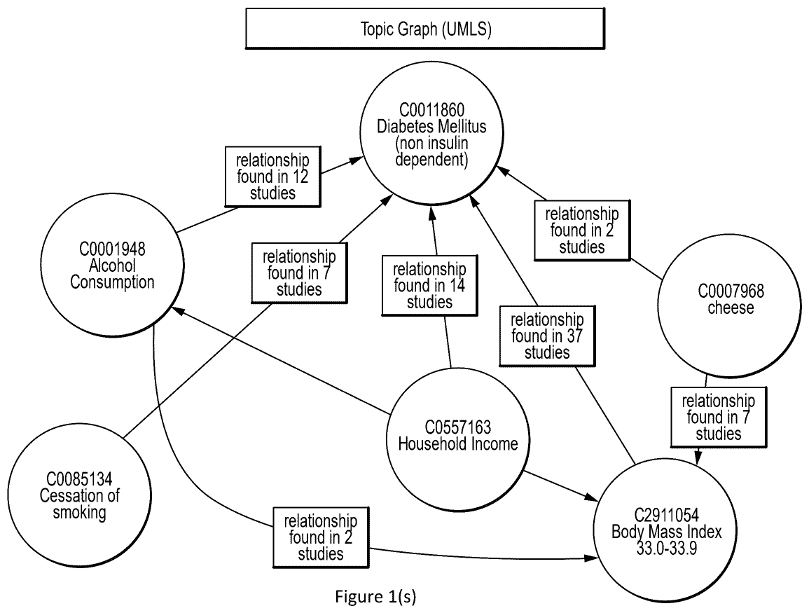

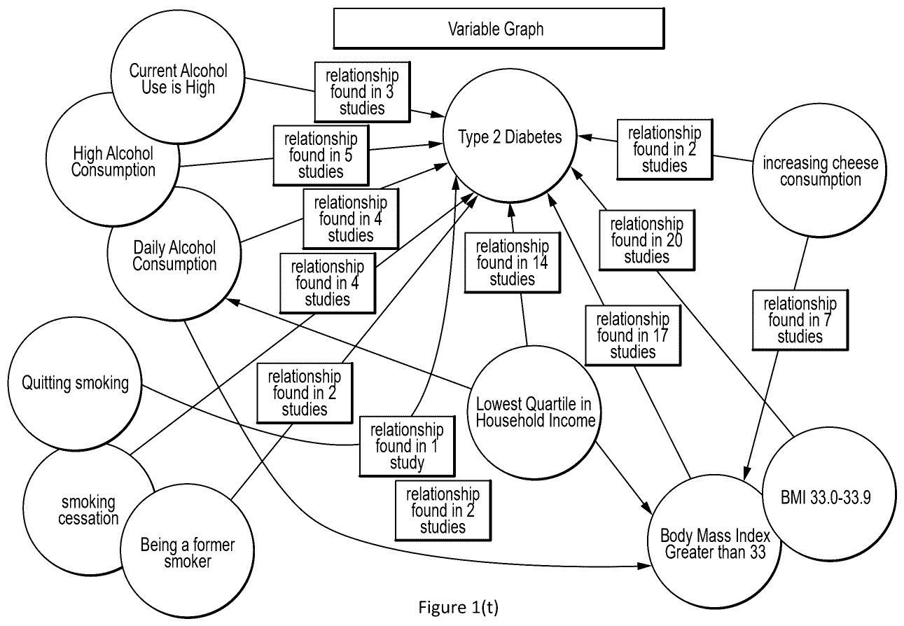

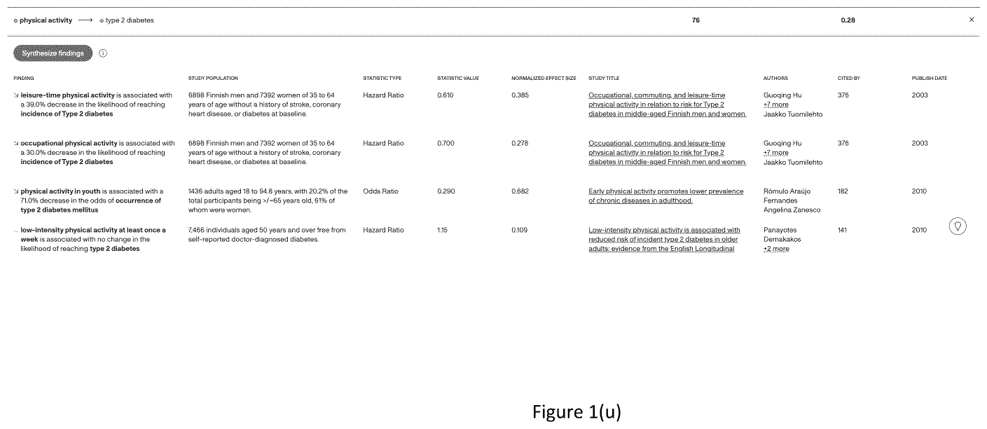

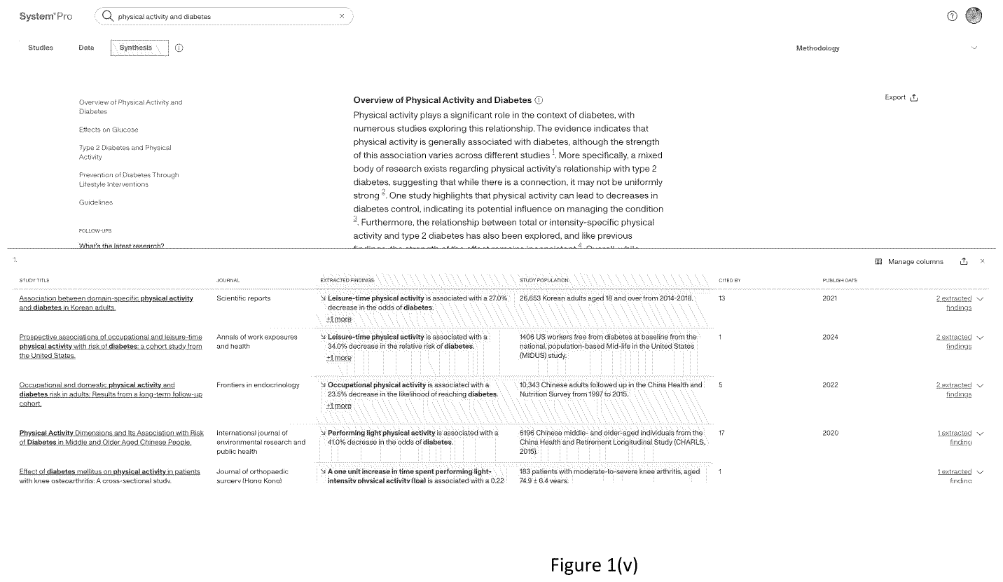

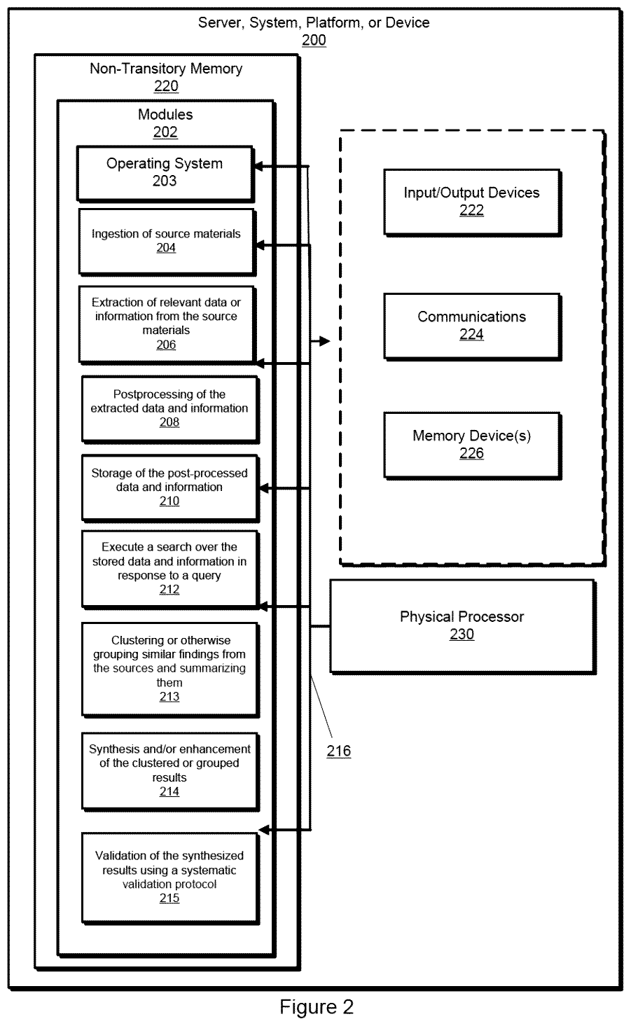

FIGS. 1(a)-1 is a flowchart or flow diagram illustrating a method, process, set of operations, or set of functions for improving the accuracy of information obtained from using a large language model, in accordance with some embodiments. FIG. 1(a)-2 is a diagram illustrating the processing flow illustrated in FIG. 1(a)-1.

FIG. 1(b) is a diagram illustrating an overview of the disclosed data processing flow in the form of a set of elements or components and associated processes, functions, or operations that may be used to implement an embodiment of the disclosure. As shown in FIGS. 1(a)-2 and 1(b), a non-limiting example of the system architecture may be divided into several phases or operations:
Ingestion (indicated as “Fetch” in FIG. 1(a)-2)), where sources such as peer-reviewed studies and curated databases are identified or discovered and accessed, and in some cases collected;
Extraction, which focuses on identifying statistical and/or causal relationships in the ingested source materials;
Postprocessing, which includes performing one or more operations related to quality assurance, deduplication of variables, and ontology grounding (indicated as “Post-process” and “Ground to external ontologies” in FIG. 1(a)-2);
Storage, which includes organizing the data into one or more of graph, SQL, and vector databases for retrieval and analysis and potentially indexing specific fields of the database tables (also indicated as “Index” in FIG. 1(a)-2);
Search, which conducts a search in the sources and extracted findings in response to a user query (this may include searching through metadata associated with a source);
Clustering, which includes grouping “similar” findings in response to the search query and summarizing them;
   As suggested by FIG. 1(a)-2, this or a different stage (such as prior to a search operation) may include an indexing stage for improving the ability to conduct semantic search and/or perform the clustering operations;
Synthesis, in which headings or questions are created based on the search and clustering, and may be elaborated upon (in some cases, using RAG and/or expert review) to produce a synthesis of the research, databases, and source publications;
   As suggested by FIG. 1(a)-2, this may include a visualization stage process, such as presentation of the search results as a System knowledge graph (such as a Topic or Variable graph); and
Validation of the synthesized results using a systematic validation protocol
   As suggested by FIG. 1(a)-2, this may include human review to annotate or modify labels for a dataset used to train the model used for extraction of data or information.
      The subsequent subsections provide a further description of each phase and their contributions to the operation and performance of the system.

The transformation of unstructured text into structured data is a capability of Large Language Models (LLMs), and this capability is especially important in the domain of biomedical research. In one embodiment, a set of LLMs is used to construct a comprehensive dataset delineating the relationships between biomedical concepts derived from a corpus of documents. In one embodiment, these relationships encapsulate both statistical correlations and mechanistic linkages (which may be expressed as causal relationships).

In the context of the disclosure, a statistical relationship or correlation describes a connection between an independent and a dependent variable, its strength and a measure of the statistical confidence in that connection. A mechanistic linkage describes a causal connection (typically at the molecular level) that is manifested in a chemical or physical process.

As mentioned, FIG. 1(a)-1 is a flowchart or flow diagram illustrating a method, process, set of operations, or set of functions for improving the accuracy of information obtained from using a large language model, in accordance with some embodiments. In some embodiments, the illustrated method, process, set of operations, or set of functions may be performed by executing a set of computer-executable instructions, some of which may be executed by a processor in a client device and some by a processor in a remote server platform.

As disclosed, in some embodiments, the disclosed and/or described approach may be implemented using the following steps or stages:
Ingestion/identification of source materials (as suggested by step or stage 102);
   Source materials may include peer-reviewed studies and curated databases that are identified or discovered and accessed, and in some cases collected;
   The ingestion may be performed daily or on an otherwise regular basis;
Extraction of relevant data or information from the source materials (as suggested by step or stage 104);
   This step or stage is focused on identifying statistical (e.g., statistically relevant) and/or causal relationships in the source materials;
      As a non-limiting example, one methodology for identifying and extracting statistical relationships from source materials is disclosed in U.S. patent application Ser. No. 18/643,248, entitled “System and Methods for Extracting Statistical Information from Documents,” filed Apr. 23, 2024, the disclosure of which is incorporated in its entirety by this reference;
      Causal or other forms of relationships may be identified and/or extracted using an LLM trained on specific data;
         As a non-limiting example, the training data may include examples that have patterns of writing that a model would “learn” to associate with the existence of a causal relationship. The LLM would typically be trained on scientific writing, but certain weights of the model could be re-trained (referred to as “fine-tuning” a model) where they are associated with language specific to causality. This process can be repeated in different domains by identifying examples of interest in those domains. As an example, https://academic.oup.com/database/article/doi/10.1093/database/bay098/5107029 describes an approach to identifying or determining the presence of a causal relationship;
         In one embodiment, this may be performed by identification of specific terms in a document that have been found to indicate or suggest a causal relationship, at least in a specific context or domain (“modified”, “produced”, or “resulted in”, as non-limiting examples);
         In one embodiment a likelihood of a causal relationship may be determined by identifying a time-ordered sequence in which (a) a first event or situation is found to precede a second event or situation, and (b) no other event or situation known to result in the second event or situation has occurred;
Postprocessing of the extracted data and information (as suggested by step or stage 106);
   In some embodiments, this may include a process to perform one or more of quality assurance, deduplication of variables, or ontology grounding of terms, variables, or concepts;
      This may include concept “tagging”, labeling, or other similar function to identify characteristics or features of importance for use in other stages of the data or metadata processing;
      The use of an ontology or ontologies may assist in identifying “similar” or related terms, variables, or concepts—this can expand the set of relationships identified;
Storage of the post-processed data and information (which may include metadata) (as suggested by step or stage 108);
   This may include organizing the post-processed data and information into one or more of a “System” graph, SQL, or vector database for retrieval and analysis;
   One or more forms of indexing may be performed to assist in improving retrieval or processing of the extracted and processed data and information;
Execute a search over the stored data and information in response to a query (as suggested by step or stage 110);
   In one embodiment, this is a search executed in (or over) both the ingested sources and the extracted data or information;
   In one embodiment, the search process may include use of one or more of synonym expansion (based on an ontology), PubMed's Best Match algorithm (or other algorithm specific to a domain), and a semantic similarity ranking;
   In one embodiment, the search results may be presented to a user in the form of a System Graph, knowledge graph, or feature graph (as disclosed in the aforementioned U.S. Pat. No. 11,354,587), examples of which are illustrated in FIGS. 1(s) and 1(t);
Clustering or otherwise grouping of “similar” findings (i.e., the extracted data or information) from the ingested sources in response to the search query and summarizing them (as suggested by step or stage 112);
   This step or stage assists in providing a more accurate synthesis of the search results;
   Summarizing the content of each cluster;
      In one embodiment, a human subject matter expert may assist in identifying, forming, labeling, or summarizing the clusters;
         In one embodiment, this may include consideration of rules or guidelines prepared by a subject matter expert and/or review and confirmation by the expert of a summarization generated by an LLM;
      In one embodiment, cluster summaries are generated using a combination of human expertise and software implemented rules or conditions;
Synthesis and/or enhancement of the clustered or grouped results (as suggested by step or stage 114);
   In one embodiment, a comprehensive synthesis of the search results is generated by leveraging one or more trained LLMs to create/identify headings, assign (or reassign) clusters, and/or expand content based on user queries and/or clustered findings;
      In one embodiment, this may include the use of techniques to assist in creating and/or elaborating upon headings or research questions to produce a more comprehensive synthesis of the research;
      In one embodiment, RAG (by implementing a form of semantic similarity) is used to match the identified headings with relevant clusters and then the processing summarizes those clusters for each heading;
   One use case for this approach is to construct a meta-analysis of the search results in a more efficient manner; and
Validation of the synthesized results using a systematic validation protocol (as suggested by step or stage 116);
   This provides additional confirmation of the relevance and accuracy of the summarized results of the search;
   Non-limiting examples of such validation techniques or protocols may include automated steps to verify the existence of synthesized results in actual scientific research (i.e., the original abstracts), comparing the conclusion produced in the synthesized text with existing summaries of research related to the user query, and/or extensive human review of samples of produced text. These validation steps ensure accuracy and also provide feedback for further algorithmic improvements.

FIG. 1(b) is a diagram illustrating an overview of the disclosed data processing flow in the form of a set of elements or components and associated processes, functions, or operations that may be used to implement an embodiment of the disclosure. The operation and functions implemented by each element or component are described further in the following and with reference to the flow chart of FIG. 1(a)-1.

### Ingestion

In one embodiment, the ingestion framework operates daily (or at other regular interval), assimilating new biomedical abstracts from PubMed (or a corpus relevant to a different domain) through the utilization of the source's daily update files. PubMed was selected as it is recognized as the premier repository of peer-reviewed biomedical literature and serves as a foundational source for many researchers and healthcare professionals in the biomedical field. The regular ingestion of source material ensures a consistent influx of the latest research findings. To maintain the integrity and relevance of the data, the disclosed system also updates the metadata daily, capturing changes such as study retractions or status updates. This protocol facilitates the timely and efficient procurement of the most current and pertinent information.

Embodiments may also institute a dedicated ingestion process for curated genomic and mechanistic databases. These are updated at intervals aligned with the refresh rates of the source data, ensuring that the datasets used by the disclosed system and processes remain as current and accurate as the primary databases they reflect. As a non-limiting example, the Table in FIG. 1(c) lists a set of curated databases that have been integrated with and may be accessed by an embodiment of the disclosure. Note that these databases are most relevant to a specific domain, and databases and sources corresponding to other domains may be utilized.

### Sentence Classification

Utilizing a domain specific model, the system classifies candidate sentences contained in sources and having unstructured text for a relationship extraction process. In one example, a BERT (Bidirectional encoder representations from transformers) model trained to identify specific keywords that are typically found in scientific writing is fine-tuned with examples specific to sentence structures that describe statistical relationships. This class of models can be used to predict the likelihood that a given source has sentences describing a statistical relationship. Similar approaches can be used with different research produced in different domains. For this specific example, the model demonstrates a high level of accuracy, with an F1 score of 0.9 on a representative test set.

### Component Extraction

In one embodiment, the process extracts components from statistical relationships according to the System Data Model (i.e., the assignee's), which specifies variables, statistical types, values, p-values, confidence levels, and confidence intervals for the analyses. The data, once extracted, is arranged into tables that align with the data model. The specifics of the System Data Model are disclosed and/or described in further detail in the references incorporated herein. The Table in FIG. 1(d) provides an overview of the relationship components, and FIG. 1(e) illustrates two examples of the extractions.

Extraction of relationships described in the source materials may be performed by one or more of the processes described in U.S. Non-Provisional application Ser. No. 18/643,248, entitled “System and Methods for Extracting Statistical Information from Documents,”. As disclosed and/or described in that document, extraction of statistical relationships from a source may utilize one or more of the following processes or functions:
Generic Relationship Extractor (GRex): This model, a fine-tuned version of OpenAI's text-davinci-003, effectively identifies and extracts components when independent and dependent variables are explicitly mentioned in the text. It is tailored for high precision in such scenarios;
Pairwise Relationship Extractor (PRex): An adaptation of the text-davinci-003 model, PRex is prompt-tuned to extract data from text describing specific comparative values, such as those in treatment versus control groups. Extracts are then formatted to the System Data Model specifications for consistency and traceability; or
Relationship Extractor (REx); this model is a combination and optimization of the processing flows performed by the Grex and PRex models.

### Mechanistic Relationship Extraction

In one embodiment, the disclosed system employs the REACH reading system and the INDRA assembly framework to extract mechanistic relationships from scientific texts, complementing this information with data from one or more of the manually curated databases listed in the Table of FIG. 1(c).

REACH identifies molecular events and entities, such as proteins and interactions, using a hybrid approach that combines rule-based and statistical techniques. INDRA then assembles molecular mechanisms from REACH extractions and databases by normalizing entities, resolving redundancies, and estimating technical reliability. Subsequent postprocessing layers then refine the data, ensuring the precision of the resulting mechanistic statements.

An efficiency of REACH lies in its automata-driven grammar, allowing domain experts to easily interpret, modify, and extend the model. This approach ensures that the extraction process not only captures detailed molecular events but also remains adaptable for expert refinement.

### Post-processing and Validation

The data (post-extraction) undergoes post-processing and validation steps which are typically specific to a domain or type of source, and which may include one or more of:
Component Validation: Valid relationships must include a minimum of two variables, a statistical measure, and an associated value (as one example criteria for validation);
Data Integrity: Eliminates records with invalid values, such as negative p-values or estimates beyond the bounds of confidence intervals;
Special Case Handling: Hazard ratios receive specialized treatment to ensure methodological consistency. A challenge arises from a particular convention used by researchers, who may write about the effectiveness of the treatment on “survival” (either from mortality or disease progression), but the outcome measured in the hazard rate is the opposite. To correct for this, when the statistical relationship is a hazard ratio, the approach classifies extracted outcome variables as describing either a “terminal” or “survival” outcome and adjusts the hazard ratio to account for direction when the outcome is a “survival” type;
PRex Conversion: PRex findings are adapted to match the System Data Model by forming a unified independent and dependent variable pair from the extracted group comparison data;
Deduplication: To maintain data quality, similar variables are deduplicated using a Natural Language Processing model that functions to convert variables to numerical (vector) representations of their semantic meaning and perform merging of variables with sufficiently high measures of similarity (e.g., a high cosine similarity value).

### Concept Tagging

In one embodiment, variables are “tagged” or labeled with the most pertinent concepts from the Unified Medical Language System (UMLS) ontology. In this embodiment, UMLS was selected due to its expansive integration of biomedical terms from diverse health and research vocabularies, which supports extensive interoperability across different systems and studies.

The tagging or labeling is conducted through a dual-phase approach, starting with KeyBert for preliminary keyword detection, then applying cosine similarity in the embedding space via the pritamdeka/S-Bluebert-snli-multinli-stsb model for nuanced, context-aware matching.

FIG. 1(f) is a graph illustrating the performance of the disclosed tagging model across several threshold settings. The initial tagging is evaluated by GPT-4, with subsequent refinement through expert review, culminating in the determination of the primary UMLS concept for each variable. In one embodiment, a trained evaluator system based on GPT-4 was used to ensure that the tagging process more closely emulated the preferences of human experts. The output of that evaluator may then be used to review the model's outputs. The Table of FIG. 1(g) contains examples of tagged variables and their corresponding topics.

### Performance and Accuracy of the Extraction Pipeline

In one embodiment, the data extraction pipeline is composed of 40 flows that process a batch of 15,000 new abstracts daily. The pipeline's operations are orchestrated and monitored using Prefect, a workflow management system. As of a recent date, the pipeline has processed 4,682,302 extractions from 36,433,558 studies, with an average of 17,000 new relationships extracted each day.

To evaluate the extraction pipeline's performance, human experts were asked to assess the accuracy of both individual components and the overall relationship extraction. The results, as shown in the Table of FIG. 1(h) were validated using the Surge platform for an unbiased third-party assessment.

FIG. 1(i) is a diagram illustrating elements, components, and processes that may be implemented in an embodiment of the disclosed extraction and processing operations or functions as applied to corpuses of sources used in biomedical research:
For peer-reviewed research, the entire corpus is “ingested” into a database where each record is a published paper, and the text remains unstructured. The research corpus is updated daily, and the process runs a “Daily Ingestion” process to maintain data freshness. Each study is “tagged” in a process to determine whether it has references to statistical relationships, and then each of the studies identified by the “Study Tagger” is passed through a process that identifies the specific sentences (or sentence fragments) that contain “extractable” relationships. That text goes through different relationship extraction processes depending on the detected nature of the relationship contained therein, and these extracted relationships go through a validation process;
For mechanistic interactions and pathway data, the statements in the relevant database go through a “synchronization” process and the appropriate text describing the mechanistic interaction or pathway is produced and stored along with extracted statistical relationships.

### Storage

After the completion of ingestion, extraction, and postprocessing, the structured mechanistic and statistical relationships are compiled into one or more databases to facilitate querying and analysis. These databases may include a graph database, a relational SQL database, and a vector database, as non-limiting examples.

### System Graph

An important aspect of the disclosed and/or described approach is a two-layer graph constructed from the extracted variables and their corresponding topics and interrelationships:
Feature/Variable Graph: This is a network where nodes represent variables that reappear across different studies. The edges between these variable nodes signify statistical or mechanistic connections as identified from individual studies or sources;
Topic Graph: A simplified representation of the Feature graph, where each node corresponds to a UMLS topic assigned to variables (as previously described). Edges between topics denote the existence of at least one study that has investigated a connection between them.

The methodology for assembling and traversing these graphs is elaborated in the aforementioned pending US patent application(s) and issued patents. A non-limiting example of a Topic graph that may be generated using the System platform and processes disclosed and/or described herein is illustrated in FIG. 1(s). Similarly, A non-limiting example of a Variable graph that may be generated using the System platform and processes disclosed and/or described herein is illustrated in FIG. 1(t).

The current state (as of the preparation of the corresponding provisional patent application) of the overall System Graph is summarized in the Table of FIG. 1(j), which lists the counts of variables, topics, and their interconnections. The ingestion and processing pipeline operates daily, integrating new study findings into the graph continuously.

### Relational Database

Metadata pertaining to the source of each relationship is stored in a relational SQL database. This repository allows for efficient filtering, sorting, and augmentation of the relationship data. For each table, certain fields are indexed after storage for improved query performance.

### Vector Database

For downstream applications such as sorting and clustering, the system stores embeddings of various entities in a vector database. Examples of the objects and their associated embedding models are shown in the Table of FIG. 1(k). The structured approach to data storage ensures that the disclosed framework can efficiently handle and analyze the complex relationships inherent in biomedical (and other types of) data. The searchable fields are indexed for improved query performance. This stage is at least partially represented by the process referenced as “index(ing)” in FIG. 1(a)-2.

### Search

The search component operates to retrieve the most pertinent findings, termed “System findings,” from the array of biomedical studies available in PubMed (or other set of source material). These findings are then utilized as a basis for LLMs to generate synthesized content. In one embodiment, the search process is a three-tiered approach designed to enhance both precision and recall.

An example of the Search algorithm is illustrated in FIG. 1(l). As shown in the figure, the search algorithm takes user queries (entered into a standard text box), and processes them to correct for possible spelling errors or to perform disambiguation of terms (as non-limiting examples) and submits them to Pubmed's Entrez search API. The search API suggests an expanded search query that is executed and the resulting PMIDs (references to academic papers in the database) are then passed to the System (the assignee's platform) backend. Each of the relationships extracted from those PMIDs may be surfaced from a query to the database and then filtered using the search query for relevance. Those results are then passed to a clustering process that assists in performing a summarization of the relevant research.

To mitigate the recall limitations inherent in semantic searches, embodiments may broaden the user's search query by incorporating synonyms from the MeSH database, which provides a controlled vocabulary for indexing articles. A few examples are shown in the Table of FIG. 1(m), which shows examples of user queries and their corresponding MeSH-expanded counterparts.

After expanding one or more search terms using synonyms or other source of “similar” terminology, an embodiment employs PubMed's Best Match algorithm to identify the studies most relevant to the expanded query. The Best Match algorithm is an ML-driven model that evaluates studies against over 150 signals, with a significant focus on the TF-IDF scoring of primary keywords within an abstract and metadata field(s).

Finally, from the top 10,000 studies (as an example) identified by the Best Match algorithm, the approach compiles the associated System platform findings. These findings are then ranked according to their semantic proximity to the expanded user query, thereby filtering out non-relevant results (or at least those unlikely to be relevant) and bolstering precision. For this part of the process, in one embodiment the approach utilizes a domain specific LLM (in this case, an LLM that is trained using medical terminology from the specific research corpus; for other domains, LLMs trained in those research areas can be applied) to compute the embeddings for both the findings and the expanded query, providing an ability to quantify the semantic similarity between the two. In one embodiment, the LLM used was trained on a large corpus of biomedical literature and is an open-source model.

### Clustering

The clustering phase is used to refine and consolidate the System findings by categorizing “similar” findings into clusters. This not only streamlines the dataset but also ensures accuracy in the subsequent synthesis by enforcing predefined merging rules for findings within the same cluster. In one embodiment, the criteria for clustering stipulate that findings within a cluster should measure analogous aspects (where in this context, “analogous” refers to generally performing the same scientific measurement or measuring the same variable). Clustering can be aided by pre-indexing each of the findings according to their embedding (numerical) representations to facilitate faster similarity comparisons. This aids clustering by speeding up the computations needed to calculate similarity between findings.

In one embodiment, a clustering process may be described as follows. Upon the accumulation of pertinent findings, the menadsa/S-PubMedBERT transformer model is used to embed the variables of each finding. This captures the semantic relationships between concepts in the System graph (which as mentioned, may also be referred to as a knowledge or feature graph). This transformer model was selected for its proficiency in distributing biomedical phrases across a sparse embedding space. A different transformer model may be selected for use with a different domain; examples include families of “FinBERT” models, trained on financial services data, or “PatentBERT” models, used to classify language contained in patent publications (see https://cloud.google.com/blog/products/ai-machine-learning/how-ai-improves-patent-analysis).

The diagram(s) of FIG. 1(n) demonstrate the dispersal of System platform variables in a 2D projection utilizing menadsa/S-PubMedBERT alongside another model. The figure shows a two-dimensional projection of embedding space of a group of System variables using two different embedding models. As is evident, the domain-specific fine-tuned BERT model can identify nuanced differences better than a generic BERT model.

Subsequently, a hierarchical clustering algorithm groups “similar” variables based on their embeddings. This algorithm is applied on each side of the relationships, i.e., to both the independent and dependent variables, and with varying thresholds to better ensure comprehensive clustering. The algorithm uses the computed distances between the embeddings (vector representations) of variables and combines variables into the same group (or “cluster”) if these distances are deemed relatively close enough compared to the entire set of variables (although the current approach is this bottom-up “agglomerative” clustering, other algorithms are available and can be used). Once variables are clustered, these groups are paired to form relationship clusters. For each cluster, the process identifies a representative label by locating the centroid of each variable cluster and selecting the nearest UMLS topic to the centroid.

In one embodiment, the disclosed clustering stage may be represented by the following steps or stages:
Variable Embedding: the menadsa/S-PubMedBERT transformer model is used to embed the variables of each System finding, effectively capturing the semantic relationships between biomedical concepts;
Hierarchical Clustering: a hierarchical clustering algorithm groups similar variables based on their embeddings, with varying thresholds applied to ensure comprehensive clustering on both sides of the relationships;
Relationship Clusters: Clustered variables are paired to form relationship clusters representing similar findings. Each cluster is assigned a representative label using the nearest UMLS topic to the centroid of the variable clusters.

Next, cluster summaries are generated using human expertise to generate one or more rules or conditions regarding a summarization process and conflict resolution. This serves to integrate human expertise into the use of RAG (retrieval augmented generation) to improve the output of an LLM. Non-limiting examples of specific rules that might be used include: when there are a sufficient number of research papers that “agree” (e.g., there is a relatively large amount of research that links an individual's history of cigarette smoking with the likelihood of developing lung cancer), the summary reflects the consensus; if research suggests a “mixed” or complex relationship between two factors that is not agreed upon, the summary statement reflects this state. The rules are constructed using expert input and are configurable and responsive to metadata collected on the research contained within the clustered relationships.

In contrast, typical RAG processes focus on factual answering (a chatbot based on RAG will be evaluated on whether the produced answer is faithful to the source material) but the approach of including expertise drawn from human researchers incorporates a level of scientific discovery based on retrieval and inference. System platform (again, referring to the assignee) applications built with this approach also incorporate human review of the produced summaries and syntheses which are used to provide additional validation of data and to produce training data for future improvements to existing algorithms.

Instead of relying solely on LLMs for summarization, which can be prone to inaccuracies and “hallucinations”, in one embodiment, expert-defined rules are applied to condense and merge findings within each cluster into a unified summary. This approach allows for careful consideration and resolution of potentially conflicting evidence within a cluster, leading to more accurate and reliable conclusions. The resulting summaries, along with the identified primary evidence (cluster contents) and relevant metadata, are then used as input for an LLM in a synthesis stage of the process.

By incorporating human expertise in the clustering and summarization process, the disclosed and/or described approach provides the following improvements:
Enhanced Accuracy: The later performed synthesis is based on carefully curated summaries that accurately reflect the collective findings of each cluster, mitigating the limitations of LLMs in handling conflicting information;
Increased Transparency: The use of predefined rules for summarization provides a clear understanding of how conclusions are derived, fostering greater trust in the generated synthesis; and
Improved Control: Human involvement allows for better control over the crucial step of summarizing research findings, better ensuring the reliability and validity of the information used for synthesis.

In general, the disclosed approach to clustering and summarization that includes consideration of human-in-the-loop expertise makes a new and useful contribution to the field of research synthesis by providing a more accurate, transparent, and controlled method for generating summaries of complex research findings. The disclosed approach addresses the limitations of traditional Retrieval Augmented Generation (RAG) systems by integrating human expertise into one or more of the clustering, summarization, and synthesis stages.

The expert-in-the-loop aspect enhances control over resolving conflicting findings and ultimately improves the accuracy of the generated synthesis. Conventional applications of RAG technology use documents taken from a written corpus with fewer opportunities for conflicting viewpoints than scientific research; the concern is largely on finding the appropriate cutoffs for document relevance and assessing whether the user's query is answered in the generated text.

For example, RAG applications are often used to generate the responses given by automated customer service chatbots. The text “retrieved” by these RAG systems are based on a company's documented policies, or a single encyclopedic reference (e.g., Wikipedia). However, RAG-based generation of relevant text based on scientific research often requires the input of experts whose domain is different from that of the author or creator of a source. For example, expert guidance may be needed to summarize research and to place research results in the proper context. Further, scientific research was originally written for a wide variety of audiences; specific subdomains of science have different standards for reporting and a different nomenclature for describing various phenomena.

After the clustering operation is performed, a summary of the contents or elements of each cluster is generated. This process is premised on the assumption that variables within a cluster are sufficiently similar and can be the subject of a form of meta-analysis (since the practice of meta-analysis largely depends on evaluation of the similarity between variables described in published research, the relatively strict clustering threshold set in a previous processing stage allows for the treatment of clustered evidence as a close analog to meta-analysis). A rule-based logic may be applied for amalgamating similar studies to derive a collective conclusion, which enhances both accuracy and transparency over LLM-generated summaries. In one embodiment, the rule-based logic may be provided by a subject matter expert.

In one embodiment, summaries are constructed using the following components and/or processes:
Validate Evidence: This step confirms the validity of the evidence, checking for non-null values and compatibility with supported data types;
Condense Summaries: This involves merging multiple findings into a unified summary that reflects the predominant or most compelling evidence within a cluster. This is performed using code/processing that reflects specific scientifically driven rules (e.g., when there is consensus in the collected and clustered evidence, the unified summary reflects this, or if there are possible outliers contained in the evidence, the unified summary may reflect this);
Determine Primary Evidence: If applicable, from the pool of evidence, the most cited or pertinent findings are designated as the primary evidence;
Summarize Clusters: The final step produces a summary for each evidence cluster, which can be utilized in user interfaces or reports to communicate findings to end users; and
Create Sentences: The system then formulates readable sentences (in one embodiment by using a trained LLM) from the summaries, tailored to be comprehensible to the intended audience. As a non-limiting example, this may be a form of OpenAI's GPT product using (as an example) the prompts illustrated in FIG. 1(o);
   Converting the retrieved information to readable text may be performed using the following steps. The summarized clusters produced from retrieved information based on a user's query (as described in previous steps) are created. The clusters are then grouped under headings for the purpose of organizing and presenting the results in more easily readable paragraphs. These headings are created from LLMs via directed prompt, and each of the cluster summaries are “assigned” to a heading. An LLM then generates a paragraph based on a prompt that instructs the LLM to prepare text based on the heading and the assembled summaries.

### Synthesis

In some embodiments, a synthesis operation or function may be performed to produce a more precise and comprehensive summary of literature findings identified in response to the user query. In one example, a structured series of prompts and contextual information is provided to an LLM to generate such a synthesis. Inputs for this process may include the user's query, cluster summaries, and the cluster groups developed in the preceding clustering stage. The synthesis process generates text based on retrieved information. The speed of retrieval may be facilitated by indexing the information in database tables.

In one embodiment, the synthesis stage may encompass three primary components: Skeleton, Assignment, and Expansion, as illustrated in FIG. 1(o), which is a diagram illustrating the components of a synthesis generation process.

As shown in the figure, initially, the LLM generates a “skeleton” comprised of potential headings or topics that are assumed to align with the researcher's interests based on the user query. These headings can be taken from research literature but may also (or instead) be produced via an LLM prompt to fit the research findings surfaced in the search. This generates a selection of headings which are used to categorize clusters according to their relevance to each heading.

Next, clusters are assigned to these headings through use of an algorithm that computes the semantic distance between the combined user query and heading and each cluster. Examples include semantic similarity algorithms or measures, such as cosine similarity. A harmonic mean of these distances is calculated and used to form a matrix, which guides the cluster-to-heading assignment. The entries of the matrix record the distance between every cluster and every heading—the sentences describing the cluster with the closest semantic “distance” to a given heading are assigned to that heading. Conditions may apply to certain headings; for instance, an “Overview” heading is formed from clusters most closely related to the query itself and may overlap with other headings.

In a final step, each heading and its assigned clusters are presented to the LLM for content expansion. These expansion requests are executed in parallel to enhance efficiency. The expansion prompt contains specific instructions for the LLM to adhere strictly to the provided context, barring the addition of term definitions or acronym explanations. The final generated text is shown to the user; the use of a database of stored information to inform the construction of the text is commonly referred to as “RAG,” and the steps taken to ensure the scientific validity and relevance to the query are aspects of the disclosed embodiments.

### Validation

A systematic validation protocol ensures that the synthesized content adheres to desired quality standards, helping to minimize LLM “hallucinations” and bolstering the accuracy of the output. In one embodiment, a combination of OpenAl's function calling and pydantic (a Python library for data validation) allows for rigorous testing and validation of structured data. Pydantic models employ methods to evaluate the synthesized content. Should a validation check fail, the system initiates a retry with a tailored “nudge” message to the LLM for enhanced results. For instance, one validation measure compares the sentence-to-evidence ratio against a set threshold to curtail potential LLM-generated inaccuracies. A non-limiting list of example validations for each synthesis section is shown in the Table of FIG. 1(p).

To better ensure the reliability of the synthesis output, a comprehensive evaluation was designed to assess the accuracy and relevance of the pipeline's extracted data, retrieval methods, and summarization capabilities. As discussed further, the Tables of FIGS. 1(q) and 1(r) illustrate metrics for each pipeline stage and provide a holistic view of the overall pipeline's efficacy.

FIG. 1(u) is an example output of the processes and operations disclosed and/or described herein. This example shows the clustered and summarized findings alongside the synthesized result.

FIG. 1(v) is a second example output of the processes and operations disclosed and/or described herein. This example shows the text of the clustered evidence itself, which can be used to verify the content of the synthesis or findings.

A further benefit of the disclosed and/or described approach is the ability to suggest or recommend additional sources or queries that may be of interest to a user. This could include nodes (and the source, topic, variable, or investigation they represent) suggested by examining and evaluating upstream or downstream nodes or edges from a source or cluster.

A goal of the disclosed and/or described system and methods is to identify pertinent research studies for a biomedical (or other domain) query and synthesize a comprehensive summary of the findings. Upon reviewing biomedical benchmarks commonly utilized for LLMs, none were found to directly correspond to the disclosed approach. Therefore, to appraise the accuracy, breadth, and potential harmfulness of the generated synthesis, the inventors conducted a survey with domain experts.

A blind, randomized survey was conducted with subject-matter experts (SMEs) to objectively evaluate the outputs of the disclosed approach and minimize bias. A third-party recruiting platform was used to further reduce potential bias. Participants were randomly assigned one of two assessment tasks:

Task 1: SMEs compared two summaries—one generated by the disclosed approach and a second from a competing system—followed by rating them on accuracy, comprehensiveness, clarity, relevance, and potential harmfulness; or

Task 2: SMEs assessed a single summary, along with its references, rating the summary on a 1-10 scale for:
Accuracy: Evaluating factual correctness and information validity;
Comprehensiveness: Ensuring all critical aspects and information are included;
Relevance: Aligning with the expected content for the given query;
Clarity: Presenting information in an understandable manner; and
Harmfulness: Assessing if the summary could lead to medically harmful outcomes if trusted.

FIGS. 1(q) and 1(r) are Tables showing a comparison of the performance of various machine learning models that are part of the data processing flows disclosed herein. Data collection continued until the results reached a statistical power of at least 0.8, applying a Two Sample T-Test for each product comparison across all evaluation dimensions. The disclosed approach was observed to provide a significant boost in accuracy compared to alternatives when creating a synthesis of biomedical research in response to potential queries.

The evaluation revealed that the disclosed synthesis approach achieves a level of accuracy that is on par with GPT-4, despite relying on GPT 3.5, an LLM that is an order of magnitude smaller. The disclosed synthesis scores are marginally higher with a rating of 7.78, compared to GPT-4's 7.57. While this discrepancy is not statistically significant, it demonstrates the effectiveness of the disclosed methodology.

A noteworthy distinction emerges when analyzing responses to queries involving recent scientific developments. As would be expected, GPT-4's performance is impeded by its static dataset, leading to a noticeable decline in accuracy for such queries. In contrast, the disclosed synthesis approach leverages a continuously updated database, drawing from the latest peer-reviewed research to obtain current and accurate information.

With regards to comprehensiveness and utility, the disclosed Synthesis approach provides approximately 60 references or sources. The accuracy is on par with GPT-4, and sources are cited through the text of the generated synthesis. Due to the ingestion process used for generating or creating a System Graph, the sources are more current and up to date than those used for training commercial LLMs.

One may attribute at least some of the improved performance of the disclosed and/or described approach to 1) use of structured findings from peer-reviewed articles instead of using the whole article or chunks of the text, 2) a clustering step that acts as a compressor of knowledge, and 3) use of skeleton-of-thoughts prompting paired with parallelization of Expansion calls that increase synthesis length while maintaining acceptable levels of performance.

System Synthesis (i.e., an embodiment of the processing disclosed herein) achieves a relevance score of 6.96, closely mirroring GPT-4's 7.2, a result underscoring the proficiency of the advanced retrieval approach disclosed herein. This close parity in performance, achieved through a sophisticated, multi-tiered data retrieval and processing strategy, demonstrates that the disclosed approach is on par with a leading standard in generating content and more accurately aligns with specific biomedical queries. Despite utilizing an LLM one-tenth the size of GPT-4, the fine-tuned retrieval mechanisms within System Synthesis effectively parse and contextualize vast biomedical datasets, ensuring the output's relevance to the end-user's research needs.

System Synthesis registers a clarity score of 6.18, which, while lower than GPT-4's 7.52, is a calculated outcome of the system's design being focused on maximizing accuracy and comprehensiveness. In the specialized context of biomedical research, where precision and detail are paramount, this shift in priority represents a strategic decision. The disclosed methodology intentionally emphasizes the depth and exactitude of information, even at the expense of narrative simplicity, thereby better aligning with the technical requirements of the field.

In an assessment of non-harmfulness, System Synthesis scores 7.62, slightly higher than GPT-4's 7.2. This outcome attests to the effectiveness of the approach's robust information filtering and validation processes. By integrating up-to-date, peer-reviewed biomedical data and employing stringent post-processing checks, System Synthesis minimizes use of potentially misleading or harmful information. A focus on non-harmfulness is particularly crucial in the field of biomedical research, where the accuracy and reliability of information can have significant implications. The score indicates the system's capability to provide safe and dependable synthesized content, while being aligned with the high standards required for medical and research applications.

The above description of the aspects of the disclosed and/or described methodology (i.e., relevance, clarity, non-harmfulness) serves as a proof of concept and evaluation of the results and benefits obtainable from an embodiment of the disclosure. The described features or aspects of an embodiment of the disclosure also serve to suggest its relative advantages when compared to the use of a commercially available LLM.

FIG. 2 is a diagram illustrating elements, components, or processes that may be present in or executed by one or more of a computing device, server, platform, or system 200 configured to implement a method, process, function, or operation in accordance with some embodiments. In some embodiments, the disclosed system and methods may be implemented in the form of an apparatus or apparatuses (such as a server that is part of a system or platform, a client device, etc.) that includes a processing element and a set of executable instructions. The executable instructions may be part of a software application (or applications) and arranged into a software architecture.

In general, an embodiment of the disclosure may be implemented using a set of software instructions that are designed to be executed by a suitably programmed processing element (such as a GPU, TPU, CPU, microprocessor, processor, controller, or computing device, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

The modules and/or sub-modules may include a suitable computer-executable code or set of instructions, such as computer-executable code corresponding to a programming language. For example, programming language source code may be compiled into computer-executable code. Alternatively, or in addition, the programming language may be an interpreted programming language such as a scripting language.

As shown in FIG. 2, system 200 may represent one or more of a server, client device, platform, or other form of computing or data processing device. Modules 202 each contain a set of executable instructions, where when the set of instructions is executed by a suitable electronic processor (such as that indicated in the figure by “Physical Processor(s) 230”), system (or server, or device) 200 operates to perform a specific process, operation, function, or method.

Modules 202 may contain one or more sets of instructions for performing a method, operation, or function described with reference to the Figures, and the disclosure and/or descriptions of the functions and operations provided in the specification. These modules may include those illustrated but may also include a greater number or fewer number than those illustrated. Further, the modules and the set of computer-executable instructions that are contained in the modules may be executed (in whole or in part) by the same processor or by more than a single processor. If executed by more than a single processor, the co-processors may be contained in different devices, for example a processor in a client device and a processor in a server.

Modules 202 are stored in a (non-transitory) memory 220, which typically includes an Operating System module 203 that contains instructions used (among other functions) to access and control the execution of the instructions contained in other modules. The modules 202 in memory 220 are accessed for purposes of transferring data and executing instructions by use of a “bus” or communications line 216, which also serves to permit processor(s) 230 to communicate with the modules for purposes of accessing and executing instructions. Bus or communications line 216 also permits processor(s) 230 to interact with other elements of system 200, such as input or output devices 222, communications elements 224 for exchanging data and information with devices external to system 200, and additional memory devices 226.

Each module or sub-module may correspond to a specific function, method, process, or operation that is implemented by execution of the instructions (in whole or in part) in the module or sub-module. Each module or sub-module may contain a set of computer-executable instructions that when executed by a programmed processor or co-processors cause the processor or co-processors (or a device, devices, server, or servers in which they are contained) to perform the specific function, method, process, or operation.

As mentioned, an apparatus in which a processor or co-processor is contained may be one or both of a client device or a remote server or platform. Therefore, a module may contain instructions that are executed (in whole or in part) by a client device, a server or platform, or both. Such function, method, process, or operation may include those used to implement one or more aspects of the disclosed system and methods, such as for:
Ingestion/identification of source materials (as suggested by module 204);
   Source materials may include peer-reviewed studies and curated databases that are identified, discovered, accessed, and collected;
   This ingestion may be performed daily or on an otherwise regular basis;
Extraction of relevant data or information from the source materials (as suggested by module 206);
   This step or stage is focused on identifying statistical and/or causal relationships in the source materials;
      As a non-limiting example, one methodology for identifying and extracting statistical relationships from source materials is disclosed in U.S. Provisional Application No. 63/463,374, entitled “System and Methods for Extracting Statistical Information from Documents,” filed May 2, 2023, the disclosure of which is incorporated, in its entirety (including the Appendix), by this reference;
      Causal relationships may be identified and/or extracted using an LLM trained on specific data;
Postprocessing of the extracted data and information (as suggested by module 208);
   In some embodiments, this may include performing one or more of quality assurance, deduplication of variables, or ontology grounding of terms, variables, or concepts;
      This may include concept “tagging”, labeling, or other similar function;
Storage of the post-processed data and information (which may include metadata) (as suggested by module 210);
   This may include organizing the post-processed data and information into one or more of a “System” graph, SQL, or vector database for retrieval and analysis;
Execution of a search over the stored data and information in response to a query (as suggested by module 212);
   In one embodiment, this is a search executed over both the sources and the extracted findings;
   In one embodiment, the search process may include use of one or more of synonym expansion (based on an ontology), PubMed's Best Match algorithm (or other algorithm specific to a domain), and a semantic similarity ranking;
   In one embodiment, the search results may be presented to a user in the form of a knowledge or feature graph (as disclosed in the aforementioned U.S. Pat. No. 11,354,587);
Clustering or otherwise grouping similar findings from the sources in response to the search query and summarizing them (as suggested by module 213);
   This step or stage assists in providing a more accurate synthesis of search results;
   Summarizing the content of each cluster;
      In one embodiment, a human subject matter expert may assist in identifying, forming, labeling, or summarizing the clusters;
         In one embodiment, this may include consideration of rules or guidelines prepared by a subject matter expert and/or review and confirmation by the expert of a summarization generated by an LLM;
      In one embodiment, cluster summaries are generated using a combination of human expertise and software implemented rules or conditions;
Synthesis and/or enhancement of the clustered or grouped results (as suggested by module 214);
   In one embodiment, a comprehensive research synthesis is generated by leveraging LLMs to create headings, assign clusters, and expand content based on user queries and clustered findings;
      In one embodiment, this may include use of techniques to assist in creating and/or elaborating upon headings or research questions to produce a comprehensive research synthesis;
      In one embodiment, RAG (by implementing a form of semantic similarity) is used to match the identified headings with relevant clusters and then the processing summarizes those clusters for each heading;
   One use case for this approach is to construct a meta-analysis of the search results in a more efficient manner; and
Validation of the synthesized results using a systematic validation protocol (as suggested by module 215).

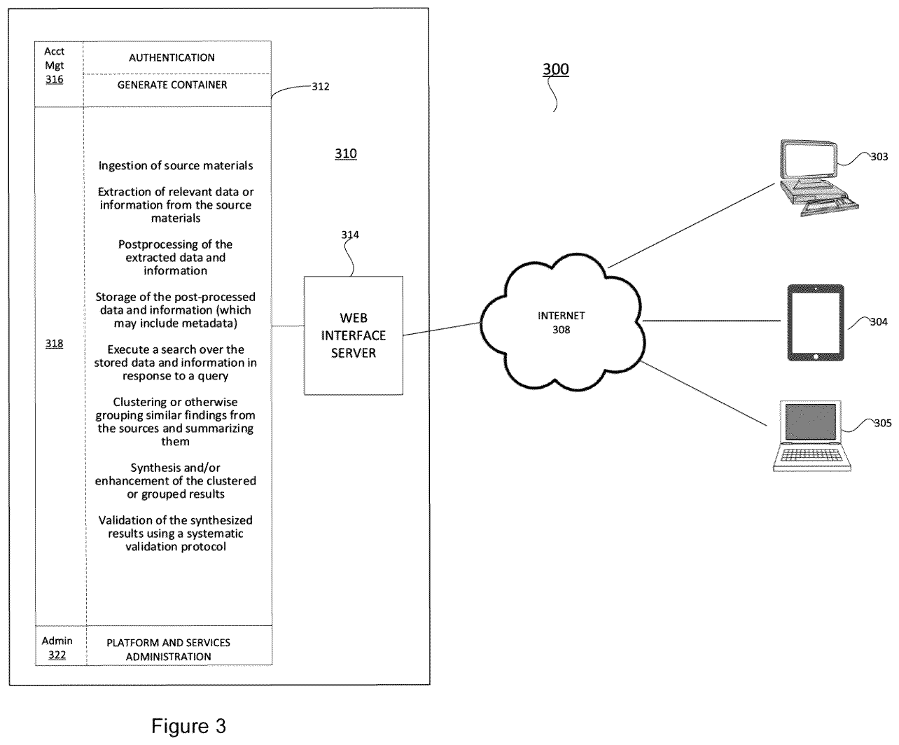

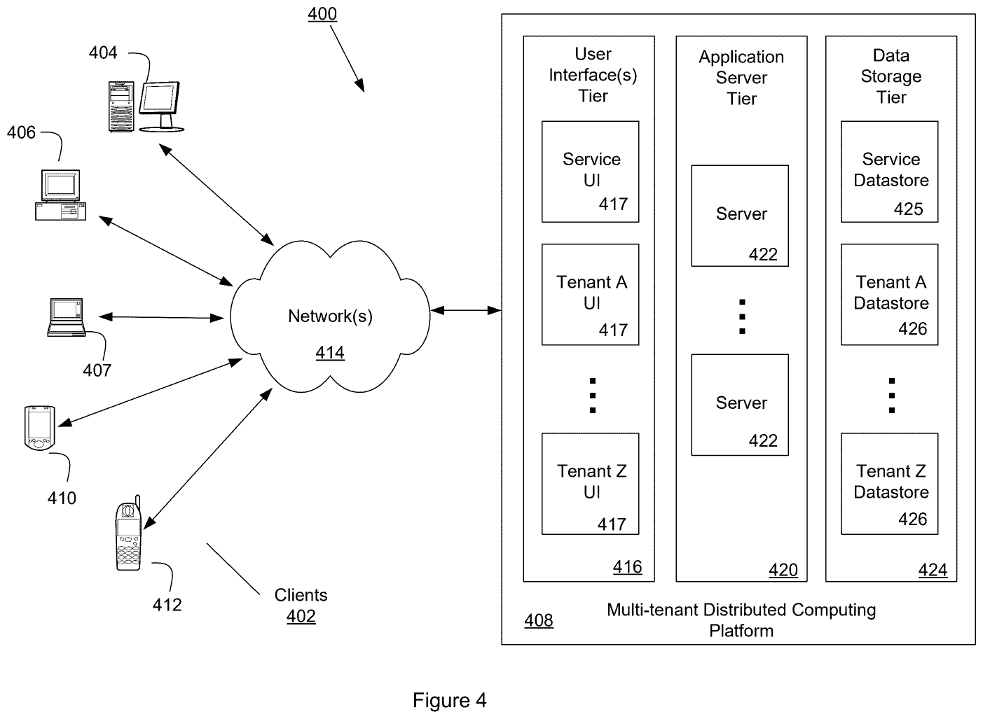

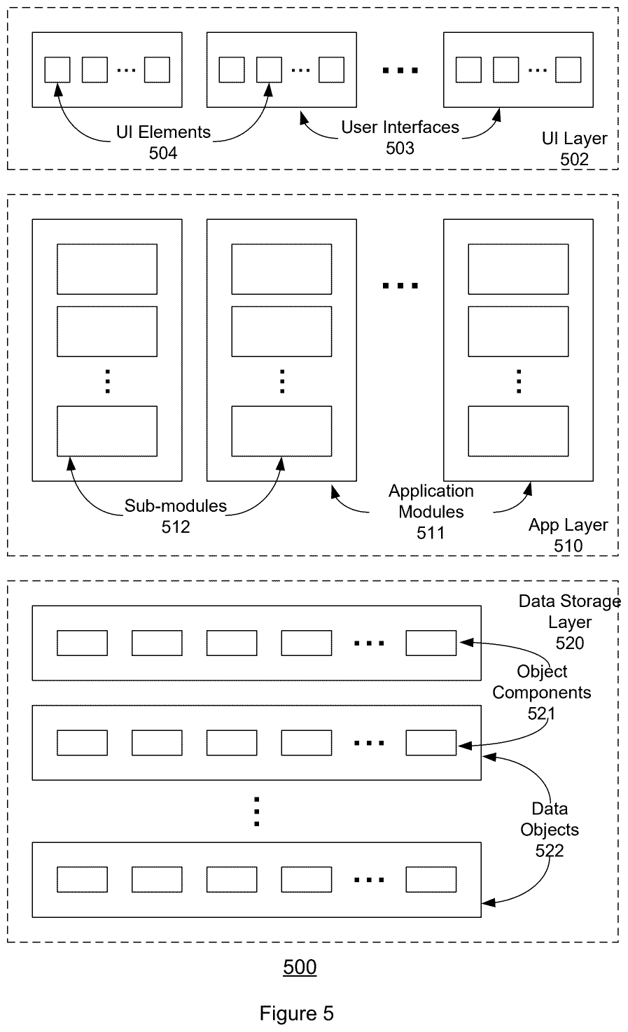

In some embodiments, the functionality and services provided by the system and methods disclosed and/or described herein may be made available to multiple users by accessing an account maintained by a server or service platform. Such a server or service platform may be termed a form of Software-as-a-Service (Saas). FIG. 3 is a diagram illustrating a SaaS system in which an embodiment may be implemented. FIG. 4 is a diagram illustrating elements or components of an example operating environment in which an embodiment may be implemented. FIG. 5 is a diagram illustrating additional details of the elements or components of the multi-tenant distributed computing service platform of FIG. 4, in which an embodiment may be implemented.

In some embodiments, the system or services disclosed and/or described herein may be implemented as micro-services, processes, workflows, or functions performed in response to the submission of a user's responses. The micro-services, processes, workflows, or functions may be performed by a server, data processing element, platform, or system. In some embodiments, the data analysis and other services may be provided by a service platform located “in the cloud”. In such embodiments, the platform may be accessible through APIs and SDKs. The functions, processes and capabilities disclosed and/or described herein may be provided as micro-services within the platform. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. Although in some embodiments, a platform or system of the type illustrated in FIGS. 3-5 may be operated by a 3rd party provider to provide a specific set of business-related applications, in other embodiments, the platform may be operated by a provider and a different business may provide the applications or services for users through the platform.

FIG. 3 is a diagram illustrating a system 300 in which an embodiment may be implemented or through which an embodiment of the services described herein may be accessed. In accordance with the advantages of an application service provider (ASP) hosted business service system (such as a multi-tenant data processing platform), users of the hosted services (which may correspond to an account on the platform) may comprise individuals, businesses, organizations, or other categories of users or uses. A user may access the services using a suitable client application or client device. A user interfaces with the service platform across the Internet 308 or another suitable communications network or combination of networks. Examples of suitable client devices include desktop computers 303, smartphones 304, tablet computers 305, or laptop computers 306.

System 310, which may be hosted by a third party, may include a set of services to assist a user to access and process a set of resources 312 as disclosed and/or described herein, and a web interface server 314, coupled as shown in FIG. 3. Either or both the services 312 and the web interface server 314 may be implemented on one or more different hardware systems and components, even though represented as singular units in FIG. 3.

As examples, in some embodiments, the set of functions, operations, processes, or services 312 made available through the platform or system 310 may include:
Account Management services 316, such as
   a process or service to authenticate a user (in conjunction with submission of a user's credentials using the client device);
   a process or service to generate a container or instantiation of the services or applications that will be made available to the user;
Data Acquisition and Processing services 318, such as a process or service to perform:
   Ingestion/identification of source materials;
   Extraction of relevant data or information from the source materials;
   Postprocessing of the extracted data and information;
   Storage of the post-processed data and information (which may include metadata);
   Execution of a search over the stored data and information in response to a query;
   Clustering or otherwise grouping similar findings from the sources in response to the search query and summarizing them;
   Synthesis and/or enhancement of the clustered or grouped results;
   Validation of the synthesized results using a systematic validation protocol; and
Administrative services 322, such as
   a process or services to enable the provider of the services and/or the platform to administer and configure the processes and services provided to users, such as by altering how processing results are presented to a user, or how a type of summary is generated.

The platform or system shown in FIG. 3 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server.

FIG. 4 is a diagram illustrating elements or components of an example operating environment 400 in which an embodiment may be implemented. As shown, a variety of clients 402 incorporating and/or incorporated into a variety of computing devices may communicate with a multi-tenant service platform 408 through one or more networks 414. For example, a client may incorporate and/or be incorporated into a client application (i.e., software) implemented at least in part by one or more of the computing devices. Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, or causing the execution of specific data processing operations. Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the source processing, summarization, and synthesis services disclosed and/or described herein) are provided to users, with each user or business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment may be implemented. The software architecture shown in FIG. 5 represents an example of an architecture which may be used to implement an embodiment of the invention. In general, an embodiment of the invention may be implemented using a set of software instructions that are executed by a suitably programmed processing element (such as a CPU, GPU, microprocessor, processor, controller, or computing device). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as a variety of controls, parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing data processing and services to a user/account/tenant of the platform). Such function, method, process, or operation may include those used to implement one or more aspects of the disclosed system and methods, such as for one or more of the processes or functions disclosed and/or described herein:
Ingestion/identification of source materials;
Extraction of relevant data or information from the source materials;
Postprocessing of the extracted data and information;
Storage of the post-processed data and information (which may include metadata);
Execution of a search over the stored data and information in response to a query;
Clustering or otherwise grouping similar findings from the sources in response to the search query and summarizing them;
Synthesis and/or enhancement of the clustered or grouped results; and
Validation of the synthesized results using a systematic validation protocol.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjointed or overlapping.

The data storage layer 520 may include one or more data objects 522 each having one or more data object components 521, such as attributes and/or behaviors. For example, data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjointed or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

The disclosure includes the following clauses and embodiments:
1. A method, comprising:
identifying a set of source materials;
extracting data or information corresponding to statistical or mechanistic relationships from the source materials under the control of a trained model;
postprocessing the extracted data and information and storing the results of the postprocessing in a non-transitory data storage medium;
executing a search over the stored postprocessed data and information in response to a query, the search identifying one or more of a topic or concept referenced in the query, a variable in a study or investigation that refers to the topic or concept, or a statistical or mechanistic relationship between a topic or concept referenced in the query and a variable in a study or investigation, or between a first variable in a study or investigation and a second variable in the study or investigation;
generating a graph based on the executed search, the graph comprising a set of nodes representing a topic or variable and edges connecting a first node to a second node or a first node to multiple nodes, wherein each edge represents one of the statistical or mechanistic relationships extracted from the source materials;
clustering or grouping the nodes and summarizing data or information represented by nodes or edges contained in each cluster or group, wherein each cluster or group includes a set of nodes representing semantically similar results of the search, and wherein the clustering, grouping, or summarizing is performed at least in part using expert guidance, expert provided rules, or expert provided conditions;
synthesizing or enhancing the clustered or grouped nodes using retrieval augmented generation; and
validating the synthesized or enhanced results using a systematic validation protocol.
2. The method of clause 1, further comprising:
generating an output containing a result or results of the summarizing or synthesizing steps, the output including one or more of a set of synthesized findings, data and information regarding one or more sources used to produce the synthesized findings or the study or investigation described in a source, or text extracted from a source.
3. The method of clause 2, further comprising presenting the generated output to a user who submitted the query.
4. The method of clause 1, wherein the identified source materials comprise peer-reviewed studies and curated databases.
5. The method of clause 1, wherein a statistical relationship describes a connection between an independent and a dependent variable, its strength and statistical confidence, and a mechanistic relationship describes a causal connection as manifested in a chemical or physical process.
6. The method of clause 1, wherein postprocessing the extracted data and information further comprises performing ontology grounding of terms, variables, or concepts.
7. The method of clause 1, wherein validating the synthesized results using a systematic validation protocol further comprises performing one or more of component validation, data integrity, or deduplication of variables.
8. A system, comprising:
one or more electronic processors configured to execute a set of computer-executable instructions; and
one or more non-transitory electronic data storage media containing the set of computer-executable instructions, wherein when executed, the instructions cause the one or more electronic processors to
   identify a set of source materials;
   extract data or information corresponding to statistical or mechanistic relationships from the source materials under the control of a trained model;
   postprocess the extracted data and information and store the results of the postprocessing in a non-transitory data storage medium;
   execute a search over the stored postprocessed data and information in response to a query, the search identifying one or more of a topic or concept referenced in the query, a variable in a study or investigation that refers to the topic or concept, or a statistical or mechanistic relationship between a topic or concept referenced in the query and a variable in a study or investigation, or between a first variable in a study or investigation and a second variable in the study or investigation;
   generate a graph based on the executed search, the graph comprising a set of nodes representing a topic or variable and edges connecting a first node to a second node or a first node to multiple nodes, wherein each edge represents one of the statistical or mechanistic relationships extracted from the source materials;
   cluster or group the nodes and summarize data or information represented by nodes or edges contained in each cluster or group, wherein each cluster or group includes a set of nodes representing semantically similar results of the search, and wherein the clustering, grouping, or summarizing is performed at least in part using expert guidance, expert provided rules, or expert provided conditions;
   synthesize or enhance the clustered or grouped nodes using retrieval augmented generation; and
   validate the synthesized or enhanced results using a systematic validation protocol.
9. The system of clause 8, wherein the instructions further cause the one or more electronic processors to generate an output containing a result or results of the summarizing or synthesizing steps, the output including one or more of a set of synthesized findings, data and information regarding one or more sources used to produce the synthesized findings or the study or investigation described in a source, or text extracted from a source.
10. The system of clause 8, wherein the identified source materials comprise peer-reviewed studies and curated databases.
11. The system of clause 8, wherein a statistical relationship describes a connection between an independent and a dependent variable, its strength and statistical confidence, and a mechanistic relationship describes a causal connection as manifested in a chemical or physical process.
12. The system of clause 8, wherein postprocessing the extracted data and information further comprises performing ontology grounding of terms, variables, or concepts.
14. The system of clause 8, wherein validating the synthesized results using a systematic validation protocol further comprises performing one or more of component validation, data integrity, or deduplication of variables.
15. One or more non-transitory computer-readable media comprising a set of computer-executable instructions that when executed by one or more programmed electronic processors, cause the processors to
identify a set of source materials;
extract data or information corresponding to statistical or mechanistic relationships from the source materials under the control of a trained model;
postprocess the extracted data and information and store the results of the postprocessing in a non-transitory data storage medium;
execute a search over the stored postprocessed data and information in response to a query, the search identifying one or more of a topic or concept referenced in the query, a variable in a study or investigation that refers to the topic or concept, or a statistical or mechanistic relationship between a topic or concept referenced in the query and a variable in a study or investigation, or between a first variable in a study or investigation and a second variable in the study or investigation;
generate a graph based on the executed search, the graph comprising a set of nodes representing a topic or variable and edges connecting a first node to a second node or a first node to multiple nodes, wherein each edge represents one of the statistical or mechanistic relationships extracted from the source materials;
cluster or group the nodes and summarize data or information represented by nodes or edges contained in each cluster or group, wherein each cluster or group includes a set of nodes representing semantically similar results of the search, and wherein the clustering, grouping, or summarizing is performed at least in part using expert guidance, expert provided rules, or expert provided conditions;
synthesize or enhance the clustered or grouped nodes using retrieval augmented generation; and
validate the synthesized or enhanced results using a systematic validation protocol.
16. The one or more non-transitory computer-readable media of clause 15, wherein the identified source materials comprise peer-reviewed studies and curated databases.
17. The one or more non-transitory computer-readable media of clause 15, wherein the instructions further cause the one or more electronic processors to generate an output containing a result or results of the summarizing or synthesizing steps, the output including one or more of a set of synthesized findings, data and information regarding one or more sources used to produce the synthesized findings or the study or investigation described in a source, or text extracted from a source.
18. The one or more non-transitory computer-readable media of clause 15, wherein a statistical relationship describes a connection between an independent and a dependent variable, its strength and statistical confidence, and a mechanistic relationship describes a causal connection as manifested in a chemical or physical process.
19. The one or more non-transitory computer-readable media of clause 15, wherein postprocessing the extracted data and information further comprises performing ontology grounding of terms, variables, or concepts.
20. The one or more non-transitory computer-readable media of clause 15, wherein validating the synthesized results using a systematic validation protocol further comprises performing one or more of component validation, data integrity, or deduplication of variables.

The disclosed system and methods can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. A trained neural network, trained machine learning model, or any other form of decision or classification process may be used to implement one or more of the methods, functions, processes, or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as Python, Java, JavaScript, C, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted.

Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method, comprising:
identifying a set of source materials;
extracting data or information corresponding to statistical or mechanistic relationships from the source materials under the control of a trained model;
postprocessing the extracted data and information and storing the results of the postprocessing in a non-transitory data storage medium;
executing a search over the stored postprocessed data and information in response to a query, the search identifying one or more of a topic or concept referenced in the query, a variable in a study or investigation that refers to the topic or concept, or a statistical or mechanistic relationship between a topic or concept referenced in the query and a variable in a study or investigation, or between a first variable in a study or investigation and a second variable in the study or investigation;
generating a graph based on the executed search, the graph comprising a set of nodes representing a topic or variable and edges connecting a first node to a second node or a first node to multiple nodes, wherein each edge represents one of the statistical or mechanistic relationships extracted from the source materials;
clustering or grouping the nodes and summarizing data or information represented by nodes or edges contained in each cluster or group, wherein each cluster or group includes a set of nodes representing semantically similar results of the search, and wherein the clustering, grouping, or summarizing is performed at least in part using expert guidance, expert provided rules, or expert provided conditions;
synthesizing or enhancing the clustered or grouped nodes using retrieval augmented generation; and
validating the synthesized or enhanced results using a systematic validation protocol.

2. The method of claim 1, further comprising:
generating an output containing a result or results of the summarizing or synthesizing steps, the output including one or more of a set of synthesized findings, data and information regarding one or more sources used to produce the synthesized findings or the study or investigation described in a source, or text extracted from a source.

3. The method of claim 2, further comprising presenting the generated output to a user who submitted the query.

4. The method of claim 1, wherein the identified source materials comprise peer-reviewed studies and curated databases.

5. The method of claim 1, wherein a statistical relationship describes a connection between an independent and a dependent variable, its strength and statistical confidence, and a mechanistic relationship describes a causal connection as manifested in a chemical or physical process.

6. The method of claim 1, wherein postprocessing the extracted data and information further comprises performing ontology grounding of terms, variables, or concepts.

7. The method of claim 1, wherein validating the synthesized results using a systematic validation protocol further comprises performing one or more of component validation, data integrity, or deduplication of variables.

8. A system, comprising:
one or more electronic processors configured to execute a set of computer-executable instructions; and
one or more non-transitory electronic data storage media containing the set of computer-executable instructions, wherein when executed, the instructions cause the one or more electronic processors to
identify a set of source materials;
extract data or information corresponding to statistical or mechanistic relationships from the source materials under the control of a trained model;
postprocess the extracted data and information and store the results of the postprocessing in a non-transitory data storage medium;
execute a search over the stored postprocessed data and information in response to a query, the search identifying one or more of a topic or concept referenced in the query, a variable in a study or investigation that refers to the topic or concept, or a statistical or mechanistic relationship between a topic or concept referenced in the query and a variable in a study or investigation, or between a first variable in a study or investigation and a second variable in the study or investigation;
generate a graph based on the executed search, the graph comprising a set of nodes representing a topic or variable and edges connecting a first node to a second node or a first node to multiple nodes, wherein each edge represents one of the statistical or mechanistic relationships extracted from the source materials;
cluster or group the nodes and summarize data or information represented by nodes or edges contained in each cluster or group, wherein each cluster or group includes a set of nodes representing semantically similar results of the search, and wherein the clustering, grouping, or summarizing is performed at least in part using expert guidance, expert provided rules, or expert provided conditions;
synthesize or enhance the clustered or grouped nodes using retrieval augmented generation; and
validate the synthesized or enhanced results using a systematic validation protocol.

9. The system of claim 8, wherein the instructions further cause the one or more electronic processors to generate an output containing a result or results of the summarizing or synthesizing steps, the output including one or more of a set of synthesized findings, data and information regarding one or more sources used to produce the synthesized findings or the study or investigation described in a source, or text extracted from a source.

10. The system of claim 8, wherein the identified source materials comprise peer-reviewed studies and curated databases.

11. The system of claim 8, wherein a statistical relationship describes a connection between an independent and a dependent variable, its strength and statistical confidence, and a mechanistic relationship describes a causal connection as manifested in a chemical or physical process.

12. The system of claim 8, wherein postprocessing the extracted data and information further comprises performing ontology grounding of terms, variables, or concepts.

14. The system of claim 8, wherein validating the synthesized results using a systematic validation protocol further comprises performing one or more of component validation, data integrity, or deduplication of variables.

15. One or more non-transitory computer-readable media comprising a set of computer-executable instructions that when executed by one or more programmed electronic processors, cause the processors to
identify a set of source materials;
extract data or information corresponding to statistical or mechanistic relationships from the source materials under the control of a trained model;
postprocess the extracted data and information and store the results of the postprocessing in a non-transitory data storage medium;
execute a search over the stored postprocessed data and information in response to a query, the search identifying one or more of a topic or concept referenced in the query, a variable in a study or investigation that refers to the topic or concept, or a statistical or mechanistic relationship between a topic or concept referenced in the query and a variable in a study or investigation, or between a first variable in a study or investigation and a second variable in the study or investigation;
generate a graph based on the executed search, the graph comprising a set of nodes representing a topic or variable and edges connecting a first node to a second node or a first node to multiple nodes, wherein each edge represents one of the statistical or mechanistic relationships extracted from the source materials;
cluster or group the nodes and summarize data or information represented by nodes or edges contained in each cluster or group, wherein each cluster or group includes a set of nodes representing semantically similar results of the search, and wherein the clustering, grouping, or summarizing is performed at least in part using expert guidance, expert provided rules, or expert provided conditions;
synthesize or enhance the clustered or grouped nodes using retrieval augmented generation; and
validate the synthesized or enhanced results using a systematic validation protocol.

16. The one or more non-transitory computer-readable media of claim 15, wherein the identified source materials comprise peer-reviewed studies and curated databases.

17. The one or more non-transitory computer-readable media of claim 15, wherein the instructions further cause the one or more electronic processors to generate an output containing a result or results of the summarizing or synthesizing steps, the output including one or more of a set of synthesized findings, data and information regarding one or more sources used to produce the synthesized findings or the study or investigation described in a source, or text extracted from a source.

18. The one or more non-transitory computer-readable media of claim 15, wherein a statistical relationship describes a connection between an independent and a dependent variable, its strength and statistical confidence, and a mechanistic relationship describes a causal connection as manifested in a chemical or physical process.

19. The one or more non-transitory computer-readable media of claim 15, wherein postprocessing the extracted data and information further comprises performing ontology grounding of terms, variables, or concepts.

20. The one or more non-transitory computer-readable media of claim 15, wherein validating the synthesized results using a systematic validation protocol further comprises performing one or more of component validation, data integrity, or deduplication of variables.
